(19) United States
(12) Patent Application Publication
(10) Pub. No.: US 2013/0021538 A1
(43) Pub. Date: Jan. 24, 2013

(54) LIGHTING DEVICE, DISPLAY DEVICE AND TELEVISION RECEIVER

(71) Applicant: Yasumori Kuromizu, Osaka-shi (JP)

(72) Inventor: Yasumori Kuromizu, Osaka-shi (JP)

(73) Assignee: SHARP KABUSHIKI KAISHA, Osaka-shi, Osaka (JP)

(21) Appl. No.: 13/638,656

(22) PCT Filed: Feb. 16, 2011
(86) PCT No.: PCT/JP2011/053218

§ 371 Date: Oct. 1, 2012

(30) Foreign Application Priority Data
Apr. 14, 2010 (JP) 2010-093156

(51) Int. Cl. F21V 15/01; H04N 9/12; G02F 1/13357

(52) U.S. Cl. 348/797; 362/611; 362/614; 349/58; 348/E09.012

(57) ABSTRACT

A lighting device includes a cold cathode fluorescent tube (CCFT), a chassis housing the CCFT, and a lamp clip. The chassis includes at least three mounting through holes at least one of which is arranged on a first line and a second line. The first line and the second line are separately extending in a direction substantially perpendicular to an axial direction of the CCFT, whereby the mounting through holes are asymmetrically arranged. The lamp clip includes a main body, a lamp gripping portion capable of gripping the CCFT, and at least three mounting portions protruding from the main body. At least one of the mounting portions is each arranged on the first line and the second line, whereby the mounting portions are asymmetrically arranged. The mounting portions on the first and second lines are passed through the mounting through holes on the first and second lines, respectively.

### TECHNICAL FIELD

The present invention relates to a lighting device, a display device and a television receiver.

### BACKGROUND ART

A liquid crystal panel used for a liquid crystal display device such as a liquid crystal television does not emit light, and thus a backlight unit is required as a separate lighting device. The backlight unit is provided behind the liquid crystal panel (on a side opposite to a display surface). The backlight unit includes a chassis, a plurality of fluorescent tubes (for example, cold cathode fluorescent tubes), a plurality of optical members (diffuser sheets or the like), and a plurality of lamp clips. The chassis is made of metal or resin and has an opening on a side of the liquid crystal panel. The fluorescent tubes as lamps are housed in the chassis. The optical members are provided over the opening of the chassis for efficiently introducing lights emitted by the cold cathode fluorescent tubes toward the liquid crystal panel. The lamp clips are configured to support middle portions of the cold cathode fluorescent tubes each having an elongated tubular shape. One example of the lamp clip having such a configuration is disclosed in Patent Document 1.

### RELATED ART DOCUMENT

### Patent Document

Patent Document 1: Japanese Unexamined Patent Publication No. 2006-114445

### PROBLEM TO BE SOLVED BY THE INVENTION

Some backlight units may have a problem when a lamp clip is not in a specific orientation at the time of mounting in the chassis. However, the conventional lamp clips are not designed in consideration of such a problem. All that has done to prevent this problem is to inform operators to strictly follow instructions about how to mount the lamp clip. This creates uncertainly and this problem was not sufficiently dealt with. Further, if it is noticed that the mounted lamp clip is not in a proper orientation, the lamp clip should be detached and mounted again in a proper orientation. This reduces the efficiency of the mounting operation.

### DISCLOSURE OF THE PRESENT INVENTION

The present invention was made in view of the above circumstances. It is an object of the present invention to prevent the lamp holder from being mounted in an orientation different from a predetermined orientation and to facilitate the mounting operation.

### MEANS FOR SOLVING THE PROBLEM

A lighting device according to the present invention includes a linear light source, a chassis housing the linear light source, and a light source holder. The chassis includes at least three mounting through holes. At least one of the mounting through holes is arranged on a first line and at least one of the mounting through holes is arranged on a second line. The first line and the second line separately extend in a direction substantially perpendicular to an axial direction of the linear light source, whereby the mounting through holes are asymmetrically arranged. The light source holder includes a main body attached to the chassis, a light source gripping portion provided on the main body, and at least three mounting portions protruding from the main body to the chassis. The light source gripping portion is capable of gripping the linear light source. At least one of the mounting portions is arranged on the first line and at least one of the mounting portions is arranged on the second line, whereby the mounting portions are asymmetrically arranged. The mounting portions on the first line and the second line are passed through the mounting through holes on the first line and the second line, respectively, such that an edge of each mounting through hole is sandwiched between the corresponding mounting portion and the main body.

In this configuration, if an operator tries to mount the light source holder in an orientation different from a proper orientation, i.e., in an improper orientation, on the chassis, not all of the at least three mounting portions asymmetrically arranged in two different positions in the axial direction of the linear light source fit together with the corresponding mounting through holes. This does not allow the light source holder to be mounted, and then the operator realizes that the light source holder is not in the predetermined orientation. Then, the operator sets the light source holder in the predetermined orientation and begins the mounting operation again.

The mounting portions and the corresponding mounting through holes are asymmetrically arranged at at least two different positions in the axial direction of the linear light source. Accordingly, the operator can easily recognize the orientation of the light source holder by visually checking the mounting portions before the mounting operation. With this configuration, the operator is less likely to try to mount the light source holder in the improper orientation on the chassis. Thus, the mounting operation can be facilitated.

The following configurations are preferable as aspects of the present invention.

(1) The mounting portions may include at least two first mounting portions arranged on the first line extending in the direction substantially perpendicular to the axial direction of the linear light source and at least one second mounting portion arranged on the second line extending separately from the first line in the direction substantially perpendicular to the axial direction of the linear light source. The mounting through holes may include at least two first mounting through holes arranged on the first line extending in the direction substantially perpendicular to the axial direction of the linear light source and at least one second mounting through hole arranged on the second line extending separately from the first line in the direction substantially perpendicular to the axial direction of the linear light source. In this configuration, the at least two first mounting portions and the at least two first mounting through holes are arranged at substantially the same position in the axial direction of the linear light source, and the at least one second mounting portion and the at least one second mounting through hole are arranged at the position different from the position of the first mounting portions and the first mounting through holes in the axial direction of the linear light source. Accordingly, the orientation of the light source holder can be easily recognized compared with the mounting portions that are all positioned at different positions in the axial direction of the linear light source. This facilitates the mounting operation.

(2) The first mounting portions may be arranged adjacent to each other on the main body in the direction substantially perpendicular to the axial direction of the linear light source. With this configuration, the orientation of the light source holder can be easily recognized by visually checking the first mounting portions arranged adjacent to each other.

(3) The second mounting portion may be arranged on an end portion of the main body in a direction substantially perpendicular to the axial direction of the linear light source. With this configuration, the orientation of the light source holder can be easily recognized by visually checking the second mounting portion arranged on the end portion of the main body.

(4) The first mounting portions may be each arranged on a middle portion and one end portion of the main body in the direction substantially perpendicular to the axial direction of the linear light source. Further, the second mounting portion may be arranged on the other end portion of the main body in the direction substantially perpendicular to the axial direction of the linear light source. With this configuration, the orientation of the light source holder can be easily recognized by a positional relation between the first mounting portions and the second mounting portion.

(5) The first mounting portions and the second mounting portion may be equally spaced apart from each other in the direction substantially perpendicular to the axial direction of the linear light source. With this configuration, the positional relation between the first mounting portions and the second mounting portion in the axial direction of the linear light source can be accurately recognized compared with the first mounting portions and the second mounting portion that are arranged to be unequally spaced apart from each other. Thus, the orientation of the light source holder can be easily recognized.

(6) The light source gripping portion provided on the main body may include a plurality of light source gripping portions. At least one of the light source gripping portions may be arranged on the first line on which the first mounting portions are arranged. With this configuration, the size of the main body can be made smaller in the axial direction of the linear light source compared with the light source gripping portions that are all arranged at different positions than the first mounting portions in the axial direction of the linear light source.

(7) One of the at least one of the light source gripping portions arranged on the first line on which the first mounting portions are arranged may be located at a position substantially identical with a position of the first mounting portions on the first line. With this configuration, the size of the main body can be made smaller in the axial direction of the linear light source compared with the light source gripping portions that are all arranged at different positions than the first mounting portions in the direction substantially perpendicular to the axial direction of the linear light source.

(8) One of the at least one of the light source gripping portions arranged on the first line on which the first mounting portions are arranged may overlap with one of the first mounting portions in a plan view. With this configuration, the position of the light source gripping portion can be easily recognized by visually checking the first mounting portion. Conversely, the position of the first mounting portion can be easily recognized by visually checking the light source gripping portion.

(9) One of the at least one of the light source gripping portions may be arranged on the first line at a position substantially identical with a position of the second mounting portion in the direction substantially perpendicular to the axial direction of the linear light source. With this configuration, the size of the main body can be made smaller in the axial direction of the linear light source compared with the light source gripping portions that are all arranged at different positions than the second mounting portion in the direction substantially perpendicular to the axial direction of the linear light source.

(10) The light source holder may be configured such that the edge of each of the mounting through holes is sandwiched between each of the mounting portions and the main body when the light source holder is slid in the axial direction of the linear light source with the mounting portions being passed through the corresponding mounting through holes. With this configuration, even if the amount of sliding of the light source holder is too much or too less, a change in a positional relation between the light source gripping portion and the linear light source in a direction intersecting with the axial direction of the linear light source is less likely to occur. Accordingly, when the linear light source is gripped by the light source gripping portion, excessive force is less likely to act on the linear light source, and thus, the linear light source can be stably held.

(11) Each of the mounting through holes may include a large diameter portion having a relatively large diameter, a small diameter portion having a smaller diameter than the large diameter portion, and a connecting portion that connects the large diameter portion and the small diameter portion. The small diameter portion having an edge may be sandwiched between the mounting portion and the main body. In this configuration, when the light source holder is slid after the mounting portions are passed into the large diameter portions of the corresponding mounting through holes, the mounting portions are moved into the small diameter portions through the connecting portions and the edge of each of the small diameter portions is sandwiched between the mounting portion and the main body. Accordingly, the light source holder can be stably mounted on the chassis.

(12) The light source holder further may include an extended portion extending from the main body in a direction opposite to a direction in which the light source holder is slid for mounting. A part of the extended portion may overlap with the large diameter portion in a plan view with the mounting portion being in the small diameter portion. In this configuration, when the light source holder is slid after the mounting portion is passed into the large diameter portion of the mounting through hole, the mounting portion enters the small diameter portion and the edge of the small diameter portion is sandwiched between the mounting portion and the main body, and further at least a part of the extended portion overlaps with the large diameter portion in a plan view. As described above, the large diameter portion is not exposed, because it is covered with the extended portion. Further, the extended portion only protrudes from parts of the main body, and thus the light source holder can have a small surface area compared with the light source holder including a main body having a large width over the entire length thereof. Thus, the brightness unevenness is less likely to occur and a material cost can be reduced.

(13) The extended portion may have a width larger than the diameter of the large diameter portion. With this configuration, the extended portion can cover the entire area of the large diameter portion.

(14) The extended portion may include at least three extended portions arranged corresponding to the mounting portions. The extended portions may have two different lengths measured in the axial direction of the linear light source and asymmetrically arranged. In this configuration, in addition to the mounting portions, the extended portions are asymmetrically arranged. Thus, the orientation of the light source holder can be further easily recognized. Further, compared with the extended portions all of which have the same protruding length, the light source holder having the extended portion of this configuration can have a smaller surface area. Thus, the uneven brightness is less likely to occur and a material cost can be reduced.

(15) The light source gripping portion provided on the main body may include a plurality of light source gripping portions. Further, the light source gripping portions may be arranged at positions substantially aligned in the direction substantially perpendicular to the axial direction of the linear light source. With this configuration, the linear light source is gripped by the light source gripping portions at substantially the same position in the axial direction. Thus, the linear light source can be stably held. When the light source gripping portions are arranged in the above manner, the orientation of the light source holder cannot be easily recognized by visually checking the light source gripping portion, but the orientation of the light source holder can be easily recognized by visually checking the mounting portions. This sufficiently facilitates the mounting operation.

(16) The lighting device may further include an optical member arranged on a light exit side of the linear light source, and a supporting member provided on the main body of the light source holder. The supporting member supports the optical member. With this configuration, the optical member can be supported by the supporting member, and thus, the positional relation between the linear light source and the optical member can be maintained. This enables an operator to mount the light source holder on the chassis by manipulating the supporting member and facilitates the mounting operation.

(17) The supporting member and the light source gripping portions may be arranged at positions substantially aligned in the direction substantially perpendicular to the axial direction of the linear light source. In this configuration, the orientation of the light source holder cannot be easily recognized by visually checking the supporting member and the light source gripping portion, but the orientation of the light source holder can be easily recognized by visually checking the mounting portion. This sufficiently facilitates the mounting operation.

(18) The supporting member and the light source gripping portions may be equally spaced apart from each other in the direction substantially perpendicular to the axial direction of the linear light source. In this configuration, the orientation of the light source holder cannot be easily recognized by visually checking the supporting member and the light source gripping portion, but the orientation of the light source holder can be easily recognized by visually checking the mounting portion. This sufficiently facilitates the mounting operation.

(19) The light source gripping portions may be symmetrically arranged about the supporting member. In this configuration, the orientation of the light source holder cannot be easily recognized by visually checking the supporting member and the light source gripping portion, but the orientation of the light source holder can be easily recognized by visually checking the mounting portion. This sufficiently facilitates the mounting operation.

(20) The supporting member may be arranged at a middle portion of the main body. Further, the light source gripping portion may include at least two light source gripping portions. The light source gripping portions may be arranged at end portions of the main body such that the supporting member is located therebetween. With this configuration, compared with the supporting member eccentrically provided at a position closer to the edge of the main body, the supporting member can be easily manipulated to mount the light source holder on the chassis. This facilitates the mounting operation.

(21) The supporting member may be arranged at substantially a center of the main body. With this configuration, the supporting member can be further easily manipulated to mount the light source holder on the chassis. This facilitates the mounting operation.

(22) One of the mounting portions may overlap with the supporting member in a plan view. With this configuration, at the time of insertion of the mounting portions into the corresponding mounting through holes, the supporting member that is arranged at a position overlapping with the one of the mounting portions can be manipulated. This further facilitates the insertion operation.

(23) One of the mounting portions may be concentrically arranged with the supporting member. With this configuration, at the time of the insertion of the mounting portion into the corresponding mounting through hole, the supporting member that is concentrically arranged with the mounting portion can be manipulated. This further facilitates the insertion operation.

(24) The light source holder may include a plurality of light source holders. The light source holders may be arranged in the chassis in a zigzag pattern. With this configuration, the light source holder arranged in the chassis is less likely to be recognized as a dark portion, and thus brightness unevenness is less likely to occur.

(25) The linear light source may be a cold cathode fluorescent tube. With this configuration, a service life of the light source can be longer and control of light can be easily performed.

Next, to solve the above problem, a display device according to the present invention includes the above-described lighting device and a display panel configured to provide display using light from the lighting device.

In the display device according to the present invention, the lamp holder is properly mounted in a predetermined position and the mounting operation is facilitated. Accordingly, defective products of the lighting device configured to supply light to the display panel are less likely to be produced and an assembling operation of the lighting device is facilitated.

The display panel may be a liquid crystal panel. The display device as a liquid crystal display device has a variety of applications, such as a television display or a personal-computer display. Particularly, it is suitable for a large screen display.

### ADVANTAGEOUS EFFECT OF THE INVENTION

According to the technology disclosed herein, the light source holder is prevented from being mounted in the improper orientation and the mounting operation can be facilitated.

### BRIEF DESCRIPTION OF THE DRAWINGS

FIG. 1 is an exploded perspective view of a general construction of a television receiver according to the first embodiment of the present invention;

FIG. 2 is an exploded perspective view illustrating a general configuration of a liquid crystal display device;

FIG. 3 is a cross-sectional view of the liquid crystal display device taken along a short-side direction thereof;

FIG. 4 is a cross-sectional view of the liquid crystal display device taken along a long-side direction thereof;

FIG. 5 is a plan view of a lamp clip;

FIG. 6 is a bottom view of the lamp clip;

FIG. 7 is a plan view illustrating a state in which the lamp clips are mounted on the chassis;

FIG. 8 is a plan view of the chassis;

FIG. 9 is a magnified plan view of mounting through holes of the chassis;

FIG. 10 is a cross-sectional view illustrating a state in which the lamp clip is mounted in the liquid crystal display device and taken along a line x-x in FIG. 12;

FIG. 11 is a plan view illustrating a state in which the mounting portions of the lamp clip in a first state fit together with the corresponding mounting through holes;

FIG. 12 is a plan view illustrating a state in which the lamp clip in the first orientation is slid for mounting;

FIG. 13 is a plan view illustrating a state in which the mounting portions of the lamp clip in a second state do not fit together with the corresponding mounting through holes,

FIG. 14 is a cross-sectional view taken along a line xiv-xiv in FIG. 13;

FIG. 15 is a bottom view of the lamp clip according to a second embodiment of the present invention;

FIG. 16 is a magnified plan view of mounting through holes of the chassis;

FIG. 17 is a plan view of the lamp clip according to a third embodiment of the present invention;

FIG. 18 is a plan view of the lamp clip according to a fourth embodiment of the present invention;

FIG. 19 is a magnified plan view of mounting through holes of the chassis; and

FIG. 20 is a cross-sectional view illustrating a state in which the lamp clip is mounted in the liquid crystal display device.

### MODE FOR CARRYING OUT THE INVENTION

### First Embodiment

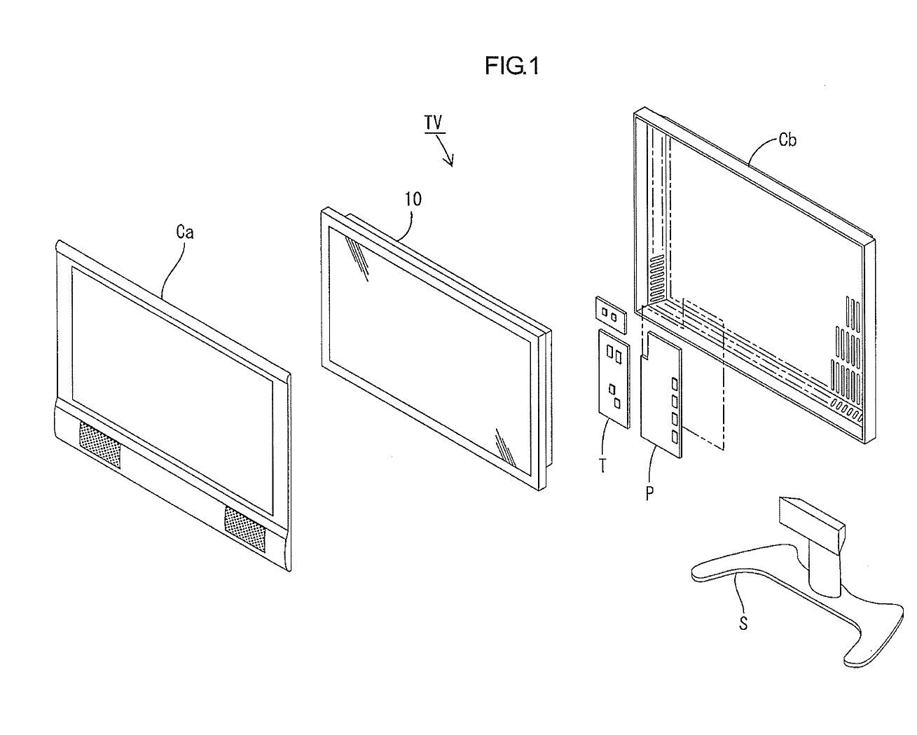

The embodiment of the present invention will be described with reference to FIG. 1 to FIG. 14.

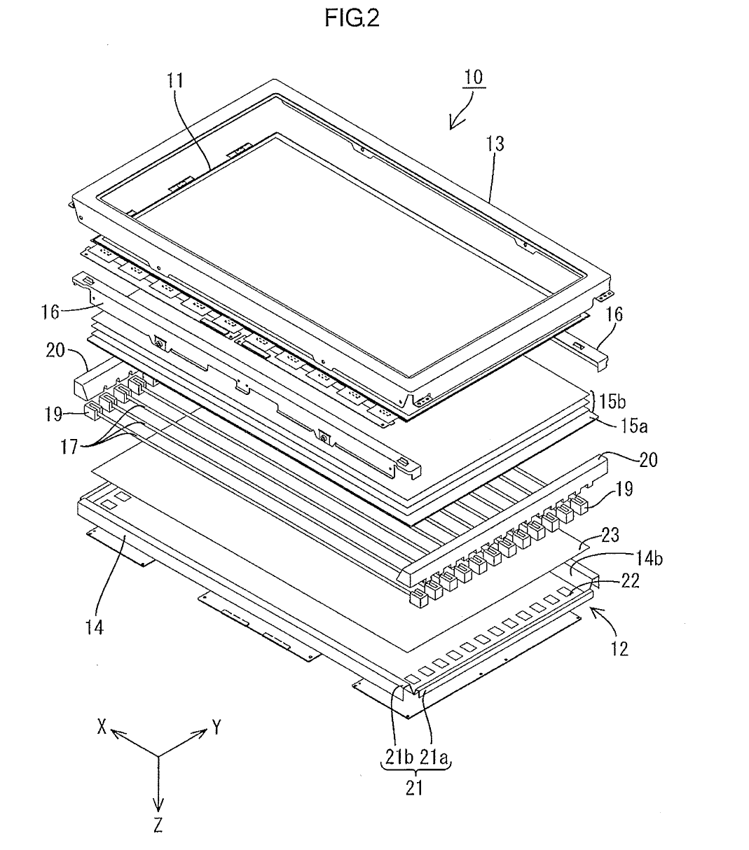

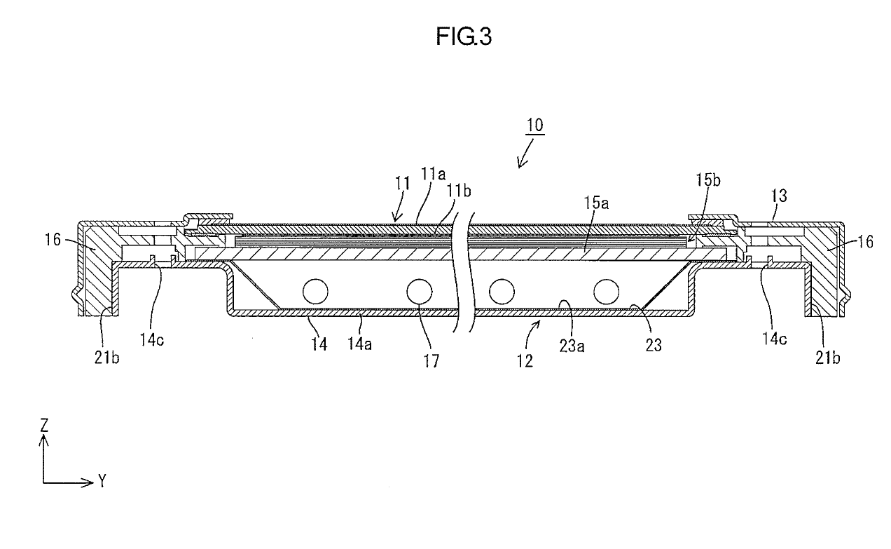

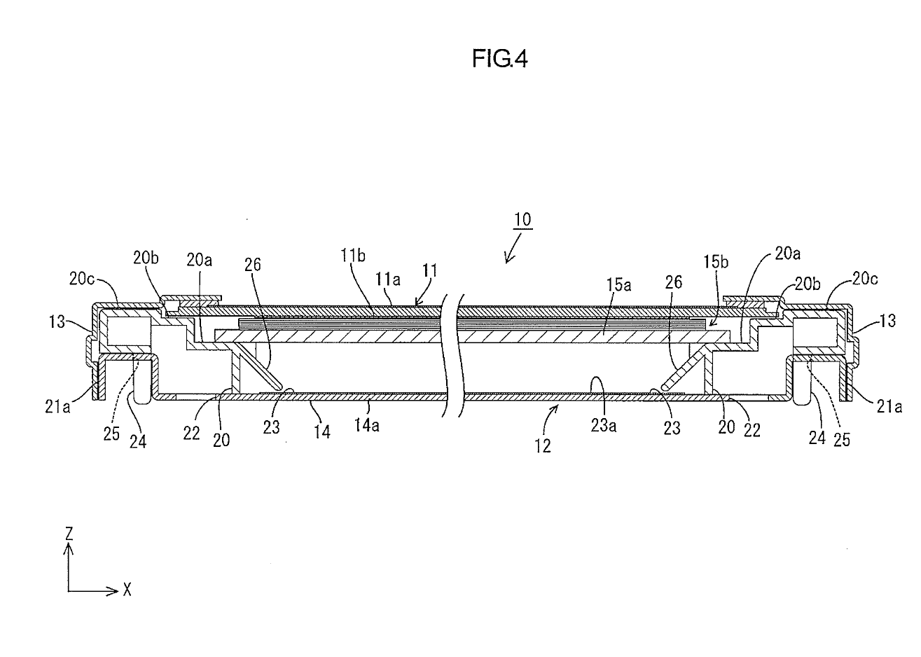

As illustrated in FIG. 1, the television receiver TV of the present embodiment includes the liquid crystal display device 10, front and rear cabinets Ca, Cb which house the liquid crystal display device 10 therebetween, a power source P, a tuner T and a stand S. An entire shape of the liquid crystal display device (a display device) 10 is a landscape rectangular. The liquid crystal display device 10 is housed in a vertical position. As illustrated in FIG. 2, the liquid crystal display device 10 includes a liquid crystal panel 11 as a display panel, and a backlight device (a lighting device) 12 as an external light source. The liquid crystal panel 11 and the backlight device 12 are integrally held by a frame shaped bezel 13 and the like. An X-axis, a Y-axis and a Z-axis are described in a part of the drawings, and a direction of each axial direction corresponds to a direction described in each drawing. An upper side in FIG. 3 and FIG. 4 corresponds to a front-surface side and a lower side in FIG. 3 and FIG. 4 corresponds to a rear-surface side.

Next, the liquid crystal panel 11 and the backlight unit 12 included in the liquid crystal display device 10 will be described (see, FIG. 2 to FIG. 4). The liquid crystal panel (a display panel) 11 is configured such that a pair of glass substrates is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, an alignment film, and the like are provided. On the other glass substrate, color filters having color sections such as red (R), green (G), and blue (B) color sections arranged in a predetermined pattern, counter electrodes, an alignment film, and the like are provided. Polarizing plates 11a, 11b are arranged on outer surfaces of the substrates (see, FIG. 3 and FIG. 4).

As illustrated in FIG. 2, the backlight unit 12 includes a chassis 14, a diffuser plate 15a, and a plurality of optical sheets 15b which is provided between the diffuser plate 15a and the liquid crystal panel 11, and a frame 16. The chassis 14 has a substantially box-shape and has an opening 14b on the light exit side (the front side, the liquid crystal panel 11 side). The optical sheets 15b are provided so as to cover the opening 14b of the chassis 14. The frame 16 provided along a long side of the chassis 14 holds a long-side edge of the optical sheets 15a such that the edge is sandwiched between the frame 16 and the chassis 14. The chassis 14 houses cold cathode fluorescent tubes (linear light sources) 17, lamp clips 18 for mounting the cold cathode fluorescent tubes 17 on the chassis 14, relay connectors 19 that relay electrical connection at ends of the respective cold cathode fluorescent tubes 17, and a holder 20 that collectively covers the ends of the cold cathode fluorescent tubes 17 and the relay connectors 19. In the backlight unit 12, the side closer to the diffuser plate 15a than the cold cathode fluorescent tube 17 is a light exiting side. The lamp clips 18 are not shown in FIG. 2 to FIG. 4.

The chassis 14 is made of metal. A metal sheet is formed into a shallow substantially box shape including a rectangular bottom plate 14a and a folded outer rim portion 21 (a short-side folded outer rim 21a and a long-side folded outer rim 21b) that rise from respective sides of the bottom plate and formed into a substantially U-shape. The bottom plate 14a of the chassis 14 has a plurality of mounting holes 22 for mounting the relay connectors 19. The mounting holes 22 are provided on ends portion in the long-side direction of the bottom plate 14a. Further, in an upper surface of the folded outer edge part 21b of the chassis 14, as illustrated in FIG. 3, fixing holes 14c are provided so that the bezel 13, the frame 16, and the chassis 14 or the like can be integrated by a screw or the like.

A reflection sheet 23 is provided on an inner surface of the bottom plate 14a of the chassis 14 (a surface facing the cold cathode fluorescent tube 17) so as to extend along the inner surface of the bottom plate 14 and cover substantially the entire of the inner surface. The reflection sheet 23 is made of synthetic resin and has a surface having white color that provides high light reflectivity. As illustrated in FIG. 3, long-side edge portions of the reflection sheet 23 rise so as to cover the folded outer rims 21b of the chassis 14, and are held between the chassis 14 and the diffuser plate 15a. The reflection sheet 23 can reflect light emitted from the cold cathode fluorescent tube 17 toward the diffuser plate 15a.

The cold cathode fluorescent tube 17 is a kind of linear light source (tubular light source). As illustrated in FIG. 2 and FIG. 3, the cold cathode fluorescent tubes 17 are housed in the chassis 14 such that the axial direction thereof matches the long-side direction (the X-axis direction) of the chassis 14. The cold cathode fluorescent tubes 17 are arranged along the short-side direction (the Y-axis direction) of the chassis 14 such that the axis lines thereof are substantially parallel to each other with a predetermined distance therebetween. The distances between the cold cathode fluorescent tubes 17, i.e., an arrangement pitch, are substantially the same. The cold cathode fluorescent tube 17 is arranged slightly above the bottom plate 14a of the chassis 14 (the reflection sheet 23), and ends thereof are fitted in the relay connector 19. The holder 20 is mounted so as to cover the relay connectors 19. In FIG. 4, the cold cathode fluorescent tube 17 is not illustrated.

The holder 20 is made of synthetic resin having white color. The holder 20 has an elongated box-like shape extending along the short-side direction of the chassis 14 and covers the end portions of the cold cathode fluorescent tubes 17. As illustrated in FIG. 4, the holder 20 has a stepped surface on which the diffuser plate 15a and the liquid crystal panel 11 can be placed at different levels. A part of the holder 20 overlaps with the short-side folded outer rim 21a of the chassis 14 such that the part of the holder 20 and the short-side folded outer rim 21a form a side wall of the backlight unit 12. An insertion pin 24 protrudes from a surface of the holder 20 which faces the short-side folded outer rim 21a of the chassis 14. The holder 20 is mounted on the chassis 14 by inserting the insertion pin 24 into an insertion hole 25 extending through an upper surface of the short-side folded outer rim 21a.

The stepped surface of the holder 20 has three steps parallel to the surface of the bottom plate 14a of the chassis 14. On a first step 20a that is the lowest step, the short-side edge portion of the diffuser plate 15a is placed. Further, from the first step 20a, a sloping surface 26 sloping toward the inner surface of the bottom plate 14a of the chassis 14 extends. On a second step 20b of the stepped surface of the holder 20, the short-side edge portion of the liquid crystal panel 11 is placed. A third step 20c that is the highest step of the stepped surface of the holder 20 is arranged so as to overlap with the folded outer rim 21a of the chassis 14 and contact with the bezel 13.

The diffuser plate 15a includes a plate member made of synthetic resin and light scattering particles dispersed therein. The diffuser plate 15a has a function for diffusing linear light emitted from the cold cathode fluorescent tube 17 as the linear light source. As described above, the short-side edge portion of the diffuser plate 15a is placed on the first step 20a of the holder 20 and is not restrained in the vertical direction. As illustrated in FIG. 3, the long-side edge portion of the diffuser plate 15a is sandwiched between the chassis 14 (the reflection sheet 23) and the frame 16 so that the long-side edge portion of the diffuser plate 15a is fixed.

The optical sheets 15b arranged on the diffuser plate 15a include, a diffuser sheet, a lens sheet, and a reflection-type polarizing plate in this sequence from the diffuser plate 15a side. The optical sheets 15b are configured to convert the light passed through the diffuser plate 15a into planar light. The liquid crystal panel 11 is provided on the front side of the optical sheets 15b. The optical sheets 15b are provided between the diffuser plate 15a and the liquid crystal panel 11.

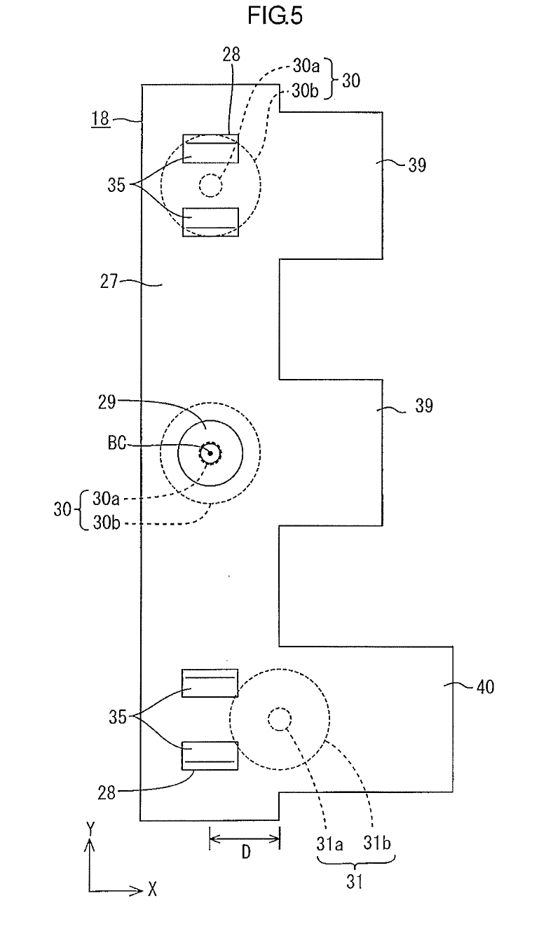

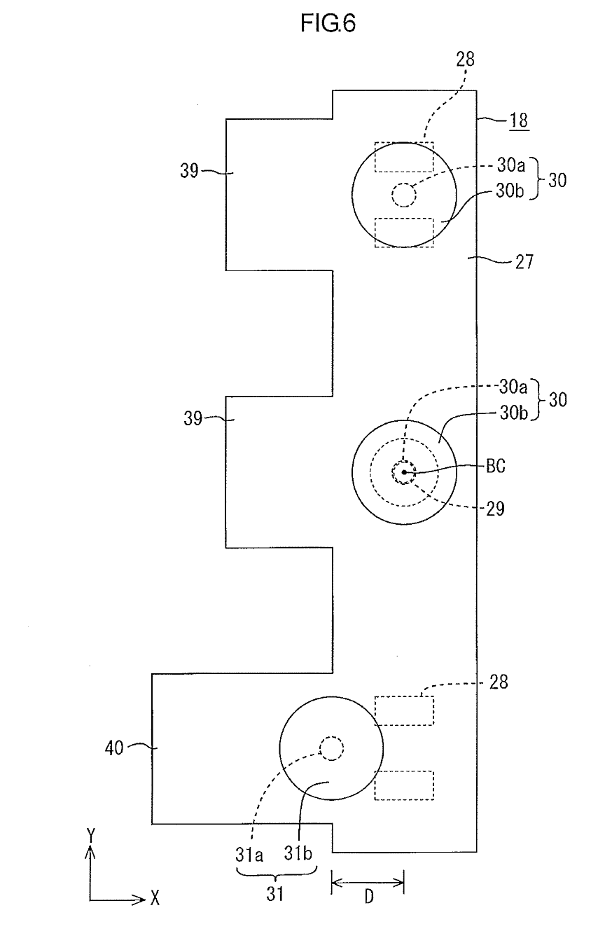

Here, the lamp clip 18 will be described in detail. The lamp clip 18 is made of synthetic resin (for example, polycarbonate), and has a surface having white color that provides highlight reflectivity. As illustrated in FIG. 5 and FIG. 6, the lamp clip 18 includes a main body 27 (a mounting plate) that has substantially a plate shape extending along the bottom plate 14a of the chassis 14 (the reflection sheet 23). The main body 17 has a vertically rectangular shape in a plan view. The lamp clip 18 is mounted on the chassis 14 such that the longitudinal direction (the long-side direction) of the main body 27 substantially matches the Y-axis direction, that is, the short-side direction of the chassis 14, and the width direction (the short-side direction) of the main body 27 substantially matches the X-axis direction, that is, the long-side direction of the chassis 14. In other words, the lamp clip 18 is mounted on the chassis 14 such that the longitudinal direction of the main body 27 substantially matches the direction (the Y-axis direction) that is perpendicular to the axial direction (the X-axis direction) of the cold cathode fluorescent tube 17 and the width direction of the main body 27 substantially matches the axial direction of the cold cathode fluorescent tube 17.

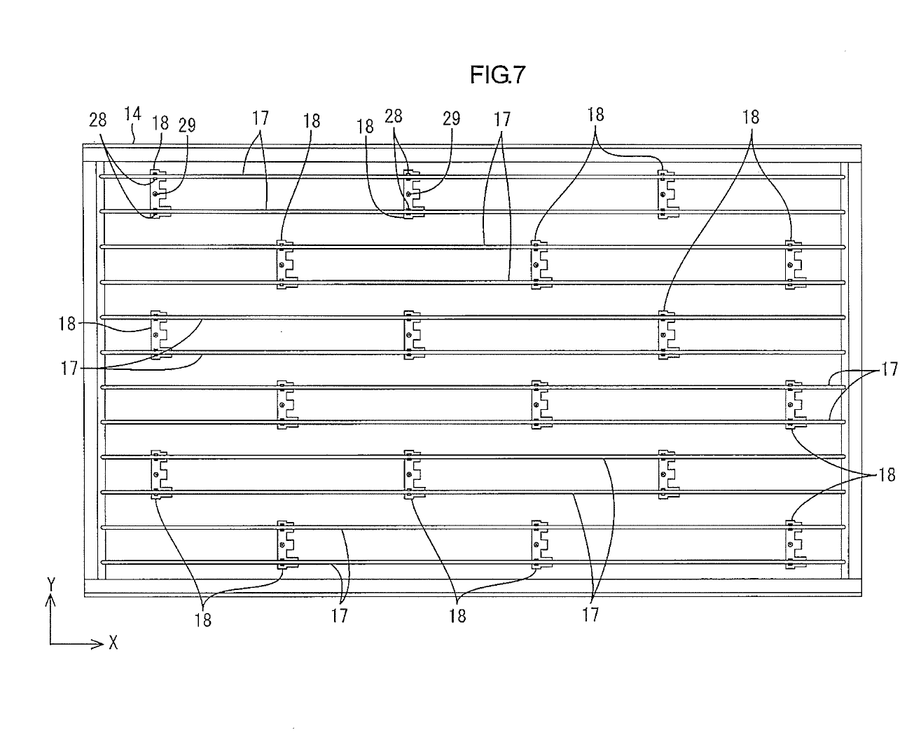

As illustrated in FIG. 7, the lamp clips 18 are arranged in the chassis 14 in a dispersed manner. The positions of the lamp clips 18 will be described in detail below. The total of 18 lamp clips 18 are arranged on the bottom plate 14a of the chassis 14 in a zigzag pattern (a grid pattern, a staggered pattern). Three lamp clips 18 are arranged in the X-axis direction (the long-side direction of the chassis 14) and six lamp clips 18 are arranged in the Y-axis direction (the short-side direction of the chassis 14). The three lamp clips 18 arranged in the X-axis direction are linearly arranged with a predetermined distance therebetween in the X-axis direction. Thus, the cold cathode fluorescent tubes 17 can be gripped at three positions that are spaced apart from each other in the axial direction. The three lamp clips 18 linearly arranged in the X-axis direction are substantially equally spaced apart from each other. The three lamp clips 18 linearly arranged in the X-axis direction are on one line. The lamp clips 18 on a next line in the Y-axis direction are arranged so as not to be directly adjacent to the lamp clips 18 on the one line. Each of the lamp clips 18 on the next line is arranged at substantially the middle of two of the lamp clips 18 on the one line. With this arrangement, the lamp clips 18 are arranged so as to be spaced apart in the X-axis direction and the Y-axis direction. Accordingly, even if the lamp clip 18 has a surface having light reflectivity different from that of the reflection sheet 23, more specifically, lower reflectivity, the lamp clips 18 are less likely to be recognized as dark portions, and thus brightness unevenness is less likely to occur.

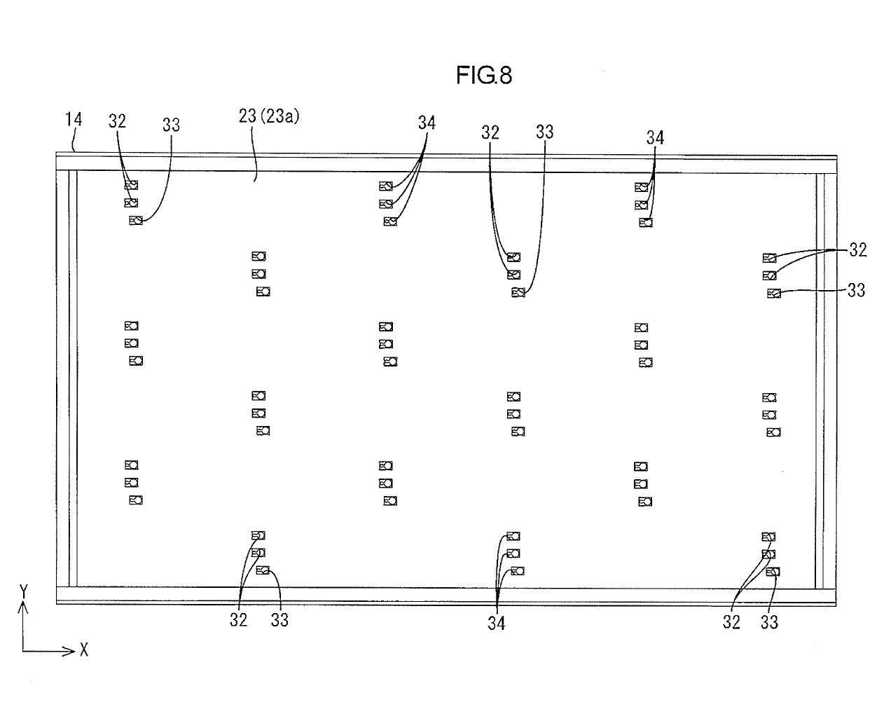

As illustrated in FIG. 8, a set of three mounting through holes 32, 33 and a set of three insertion holes 34 extend through the bottom plates 14a, 23a of the chassis 14 and the reflection sheet 23, respectively, in the thickness direction thereof. Mounting portions 30, 31 which will be described later are passed through the mounting through holes 32, 33 and the insertion holes 34 to mount the lamp clips 19. The mounting portions 30, 31, the mounting through holes 32, 33, and the insertion holes 34 will be described in detail later.

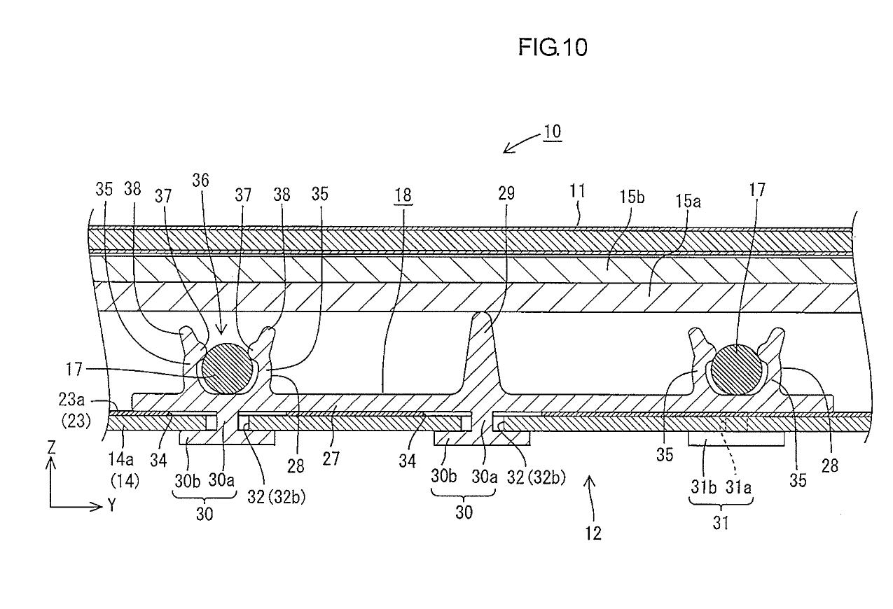

Next, a detail configuration of the lamp clip 18 will be described. As illustrated in FIG. 5 and FIG. 10, the main body 27 included in the lamp clip 18 includes the lamp gripping portion 28 and the support pin 29 on a front surface (a surface facing the diffuser plate 15a and the cold cathode fluorescent tube 17, a surface opposite to the chassis 14 side). The lamp gripping portion 28 is configured to support the cold cathode fluorescent tube 17 at a predetermined height position. The support pin 29 is configured to support the diffuser plate 15a at a position higher than the cold cathode fluorescent tube 17 (at a position closer to the light exit side).

The arrangement of the lamp gripping portion 28 and the support pin 29 will be described in detail. Two lamp gripping portions 28 are arranged on the main body 27 so as to be spaced apart from each other in the longitudinal direction (the Y-axis direction) of the main body 27. Each of the two lamp gripping portions 28 grips a separate cold cathode fluorescent tube 17. The space between the two lamp gripping portions 28 is substantially the same as the space between the cold cathode fluorescent tubes 17 arranged in the chassis 14. The two lamp gripping portions 28 are each arranged on each end portion of the main body 27 in the Y-axis direction. The distances from each of the two lamp gripping portions 28 to the center point BC of the main body 27 are substantially the same. The two lamp gripping portions 28 are arranged at substantially the same position in the X-axis direction. The two lamp gripping portions 28 are arranged on the middle portion of the main body 27 in the width direction (the short-side direction, the X-axis direction). The support pin 29 is arranged on the middle portion of the main body 27 in the width direction (the X-axis direction) and the longitudinal direction (the Y-direction). In other words, the support pin 29 and the main body 27 are substantially concentrically arranged. In further other words, the support pin 29 is arranged in the middle between the two lamp gripping portions 28 in the Y-axis direction. The arrangement of the support pin 29 in the X-axis direction is substantially the same as that of the lamp gripping portion 28. Accordingly, the two lamp gripping portions 28 and the support pin 29 are linearly arranged along the Y-axis direction with a predetermined space therebetween. The distances between the support pin 29 and each of the lamp gripping portions 28 are substantially the same. In other words, the support pin 29 is arranged in the middle between the two lamp gripping portions 28. The two lamp gripping portions 28 and the support pin 29 are symmetric with respect to the center point BC of the main body 27.

The configuration of the lamp gripping portion 28 will be described in detail. As illustrated in FIG. 10, the lamp gripping portion 28 supports a middle portion of the cold cathode fluorescent tube 17 between ends thereof to which electrodes are provided. Namely, a light emitting portion of the cold cathode fluorescent tube 17 is supported by the lamp gripping portion 28 from a rear side at a position slightly above the reflection sheet 23. The lamp gripping portion 28 has an open-end ring overall shape opening toward the front side. The lamp gripping portion 28 has a pair of arm portions 35 facing each other. Between tip portions of the arm portions 35, there is an opening 36 through which the cold cathode fluorescent tube 17 can pass to be attached or detached along the Z-axis direction (the thickness direction of the chassis 14 and the bottom plate 14a, 23a of the reflection sheet 23). The arm portions 35 are cantilevered to rise from the front surface of the main body 27 at positions spaced apart in the length direction (the Y-axis direction), and curved into a substantially arc shape. A curvature of the arm portion 35 is substantially the same as a curvature of an outer peripheral surface of the cold cathode fluorescent tube 17 to be mounted. A gap between the arm portions 35 and the cold cathode fluorescent tube 17 is substantially constant in a circumferential direction in a state that the cold cathode fluorescent tube 17 is mounted. The arm portions 35 have a symmetrical shape with respect to an axis of symmetry that extends along the Z-axis direction and passes through the middle of the lamp gripping portions 28 in the Y-axis direction. The arm portions 35 are elastically deformable in the width direction with a base end rising from the main body 27 as a fulcrum. The pair of arm portions 35 has a width smaller than the width of the main body 27.

On inner surfaces (surfaces facing the cold cathode fluorescent tube 17) of tip portions of the arm portions 35, holding protrusions 37 for holding the cold cathode fluorescent tube 17 in place are provided. The above-described opening 36 is present between the holding protrusions 37. A width of the opening 36 is slightly smaller than the outer diameter of the cold cathode fluorescent tube 17. Thus, when the cold cathode fluorescent tube 17 is attached or detached through the opening 36, the arm portions 35 are pressed by the cold cathode fluorescent tube 17 and elastically expanded and deformed. The holding protrusions 37 protrude inward from the inner surfaces of the tip portions of the arm portions 35 (toward the central axis line of the cold cathode fluorescent tube 17), and are located on the front side (the light exit side) of the cold cathode fluorescent tube 17, that is, the side to which the cold cathode fluorescent tube 17 is removed. The cold cathode fluorescent tube 17 mounted on the lamp gripping portion 28 is supported at three points, a first support point, a second support point, and a third support point. The first support point is a point on the bottom surface of the lamp gripping portion 28 directly below the middle of the cold cathode fluorescent tube 17. The second support point and the third support point are points on inner ends of the holding protrusions 37. Between the adjacent support points, a slight gap (clearance) extending circumferentially between the outer peripheral surface of the cold cathode fluorescent tube 17 and the inner surface of the lamp gripping portion 28 is present.

On outer surfaces of the tip portions of the arm portions 35, guide portions 38 for guiding the mounting operation of the cold cathode fluorescent tube 17 are provided. The guide portions 38 rise obliquely outward from the arm portions 35 and are tapered. The guide portions 38 are spaced apart from each other as each guide portion 38 slopes from a base end toward a tip. Inner surfaces of the guide portions 38 facing the cold cathode fluorescent tube 17 are sloped in the same manner. Thus, the space between the inner surfaces of the guide portions 38 facing each other gradually decreases toward the lower side in FIG. 10, that is, toward the side to which the cold cathode fluorescent tube 17 is attached, while gradually increases toward the side to which the cold cathode fluorescent tube 17 is removed. Thus, the cold cathode fluorescent tube 17 can be smoothly guided by the inner surfaces of the guide portions 38 to be mounted. The inner surfaces of the guide portions 38 are gently connected to the inner surfaces of the holding protrusions 37.

Next, the configuration of the support pin 29 will be described in detail. As illustrated in FIG. 10, the support pin 29 supports the diffuser plate 15a from a rear side of the diffuser plate 15a at a middle position rather than an outer peripheral portion supported by the holder 20 or the like. Thus, the diffuser plate 15a is less likely to be bent or warped toward the cold cathode fluorescent tube 17. The support pin 29 has a circular sectional shape when cut along a horizontal direction (FIG. 5), and has a tapered shape having a gradually decreasing diameter from a root toward a tip. In other words, the support pin 29 has a substantially conical shape. A tip portion of the support pin 29 that can be in abutting contact with the diffuser plate 15a is rounded to be a rounded surface. A height of the support pin 29 from the main body 27 is set to be higher than that of the lamp gripping portion 28. Accordingly, an operator can perform an attachment or detachment of the lamp clip 18 with respect to the chassis 14 by gripping the support pin 29. Thus, the support pin 29 can function as an operation member for the attachment and the detachment.

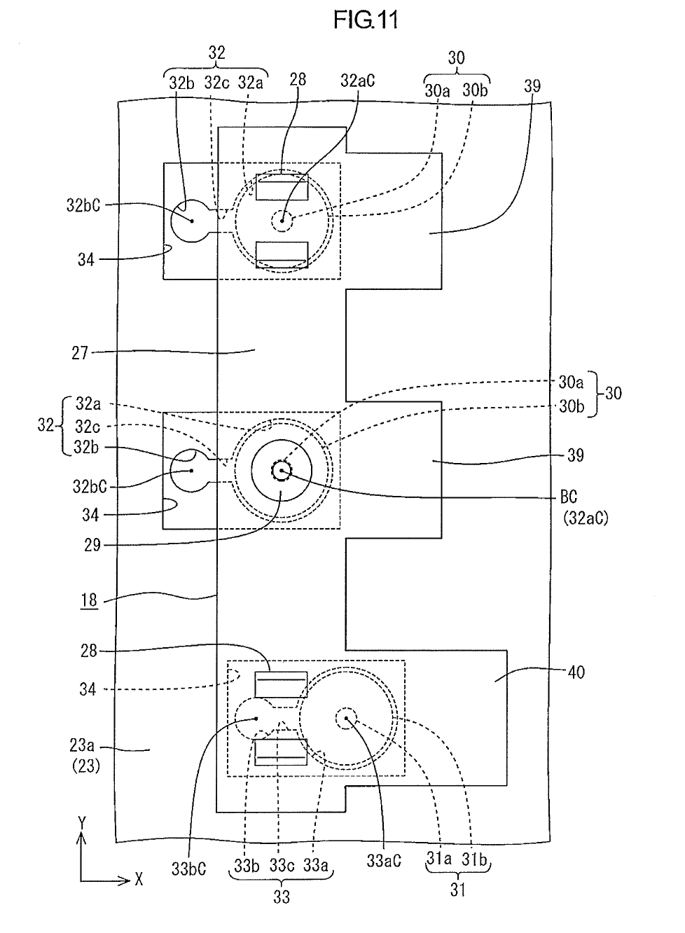

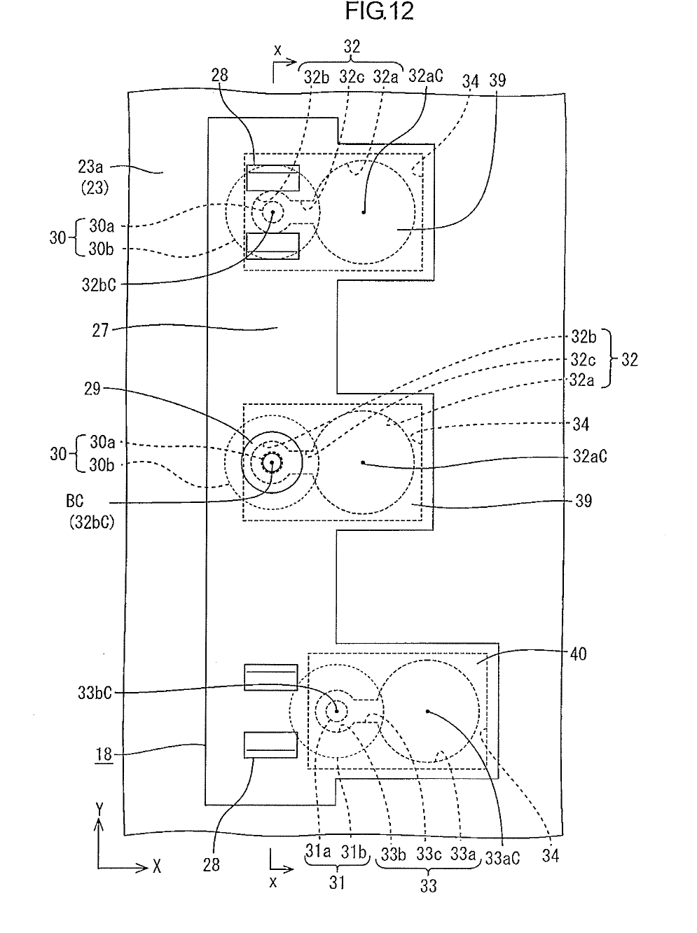

Next, the mounting configuration (holding configuration) of the lamp clip 18 with respect to the chassis 14 will be described in detail. On a rear surface of the main body (a surface facing the chassis 14 and the reflection sheet 23, a surface on a side opposite to the diffuser plate 15a and the cold cathode fluorescent tube 17 side), the total of three mounting portions 30, 31 are provided. The mounting portions 30, 31 are configured to maintain the mounting orientation of the lamp clip 18 on the chassis 14. In order to mount the lamp clip 18 on the chassis 14, the mounting portions 30, 31 are passed through the mounting through holes 32, 33 of the chassis 14, and then the lamp clip 18 is slid in the X-axis direction, i.e., the axial direction of the cold cathode fluorescent tube 17. Consequently, the edges of the mounting through holes 32, 33 are sandwiched between the mounting portions 30, 31 and the main body 27. Thus, the lamp clip 18 is mounted on the chassis 14. Hereinafter, a sliding direction in which the lamp clip 18 is slid for mounting is referred to as a front direction (the left side in FIG. 11 and FIG. 12), a sliding direction in which the lamp clip 18 is slid for detaching is referred to as a back direction (right side in FIG. 11 and FIG. 12).

The mounting portions 30, 31 are separately arranged in a long-side direction of the main body 27. As illustrated in FIG. 5, FIG. 6, and FIG. 10, the mounting portions 30, 31 each include a base portion 30a, 31a and a protrusion 30b, 31b. The base portions 30a, 31a protrude from the rear surface of the main body 27 in the Z-axis direction to the rear side (the chassis 14 side). The protrusions 30b, 31b each protrude from an end of the base portions 30a, 31b in the X-axis and Y-axis directions (the direction along the main body 27). The base portions 30a, 31a each have a circular cross-sectional shape and have a constant diameter over the entire length thereof. In other words, the base portions 30a, 31a each have a cylindrical shape. The protrusions 30b, 31b each have a flange like shape (a brim like shape) that extends radially from the end of each of the base portions 30a, 31b. The protrusions 30b, 31b each have a circular shape in a plan view and have a larger diameter than that of the base portion 30a, 31a. The protrusions 30b, 31b are arranged concentrically with the base portions 30a, 31a.

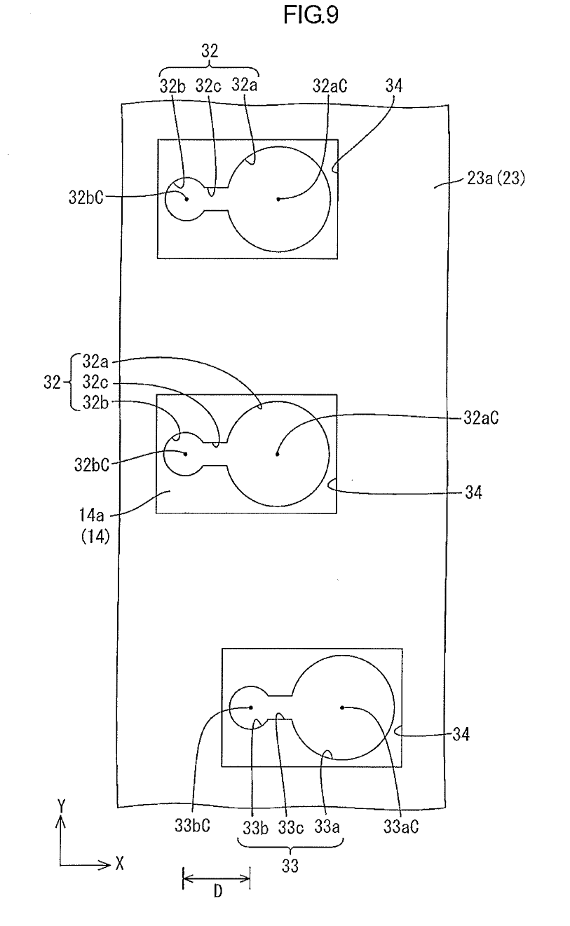

As illustrated in FIG. 9, the mounting through holes 32, 33 provided in the chassis 14 each include a large diameter portion 32a, 33a having a relatively large diameter, a small diameter portion 32b, 33b having a smaller diameter than the large diameter portion 32a, 33a and spaced apart from the large diameter portion 32a, 33a, and a connecting portion 32c, 33c arranged so as to connect the large diameter portion 32a, 33a and the small diameter portion 32b, 33b. The large diameter portions 32a, 33a and the small diameter portions 32b, 33b each have a circular shape in a plan view. The connecting portions 32c, 33c connecting the large diameter portions 32a, 33a and the small diameter portions 32b, 33b each extend straightly with a constant width in a plan view. The large diameter portions 32a, 33a each have a diameter larger than that of the protrusions 30b, 31b of the mounting portions 30, 31. Thus, the protrusions 30b, 31b, that is, the mounting portions 30, 31 can be passed through the large diameter portions 32a, 33a. On the other hand, the small diameter portions 32b, 33b each have a diameter larger than that of the base portions 30a, 31a of the mounting portions 30, 31, but smaller than that of the protrusions 30b, 31b. Thus, the protrusions 30b, 31b cannot be passed into the small diameter portions 32b, 33b.

The large diameter portions 32a, 33a and the small diameter portions 32b, 33b are arranged along the X-axis direction (the length direction of the cold cathode fluorescent tube 17, the short-side direction of the main body 27). In other words, the large diameter portions 32a, 33a and the small diameter portions 32b, 33b are arranged such that lines connecting the centers 32aC, 33aC of the large diameter portions 32a, 33a and the centers 32bC, 33bC of the respective small diameter portions 32b, 33b extend along the X-axis direction. The distance between the center 32aC, 33aC of the large diameter portion 32a, 33a and the center 32bC, 33bC of the small diameter portion 32b, 33b is equal to the sliding distance in which the lamp clip 18 is slid for mounting. The small diameter portion 32b, 33b is arranged on the left side of the large diameter portion 32a, 33a in FIG. 9, which is the front side (the sliding direction for mounting the lamp clip 18), with a predetermined distance from the large diameter portion 32a, 33a. The connecting portions 32c, 33c each have a width larger than diameter of the base portion 30a, 31a of the mounting portion 30, 31, but smaller than the diameter of the small diameter portion 32b, 33b. With this configuration, the base portion 30a, 31a can move between the large diameter portion 32a, 33a and the small diameter portion 32b, 33b through the connecting portion 32c, 33c. The center in the width direction of the connecting portion 32c, 33c is on the line connecting the center 32aC, 33aC of the large diameter portion 32a, 33a and the center 32bC, 33bC of the small diameter portion 32b, 33b.

As illustrated in FIG. 8 and FIG. 9, the insertion holes 34 are arranged in the reflection sheet 23 so as to overlap with the mounting through holes 32, 33 in a plan view when the reflection sheet 23 is arranged in the chassis 14. The insertion holes 34 each have a landscape rectangular shape in a plan view. The insertion hole 34 has a short side larger than the diameter of the large diameter portion 32a, 33a and a long side larger than the total of the diameters of the large diameter portion 32a, 33a and the small diameter portion 32b, 33b and the length of the connecting portion 32c, 33c. The insertion holes 34 are slightly larger than the mounting through holes 32, 33. The mounting through holes 32, 33 and the corresponding insertion holes 34 may have a position gap when the reflection sheet 23 is mounted on the chassis 14. The difference in size between the mounting through holes 32, 33 and the insertion holes 34 is set so as to be equal to or larger than the largest possible value of the position gap. Accordingly, the mounting through holes 32, 33 can be properly arranged in the respective insertion holes 34, and thus the mounting through holes 32, 33 are not covered with the reflection sheet 23.

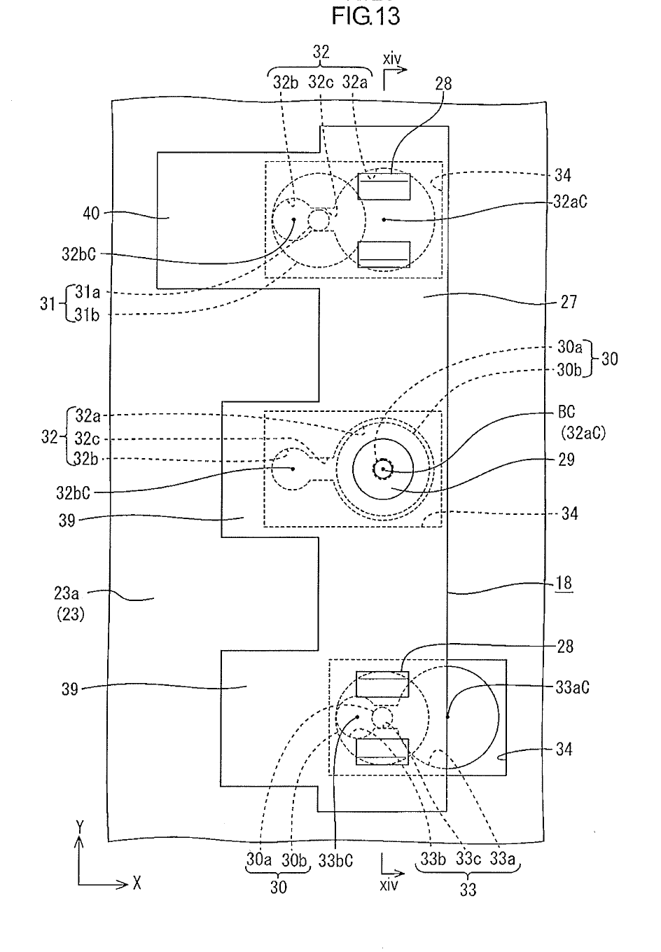

In the present embodiment, the mounting portions 30, 31 and the mounting through holes 32, 33 are arranged in a positional relation that can prevent the lamp clip 18 from being mounted in the improper orientation on the chassis 14. Specifically, when the lamp clip 18 is mounted on the chassis 14, the main body 27 is set along with the bottom plate 14a of the chassis 14 and the long-side direction of the main body 27 is set along (coincidence) with the short-side direction of the chassis 14. However, the lamp clip 18 may be rotated 180 degrees around a predetermined point. Namely, the lamp clip 18 may be arranged in two different orientations. If the lamp clip 18 is arranged in a first orientation of the two different orientations (in one orientation that is illustrated in FIG. 11), the mounting portions 30, 31 fit together with the corresponding mounting through holes 32, 33. However, if the lamp clip 18 is arranged in a second orientation (in the other orientation that is illustrated in FIG. 13), the mounting portions 30, 31 do not fit together with the corresponding mounting through holes 32, 33. Hereinafter, the specific construction will be described in details.

As illustrated in FIG. 5 and FIG. 6, three mounting portions 30, 31 are asymmetrically arranged on the main body 27 of the lamp clip 18 at two different positions in the X-axis direction (the axial direction of the cold cathode fluorescent tube 17). Similarly, as illustrated in FIG. 9, three mounting through holes 32, 33 are asymmetrically arranged in the main body 27 of the lamp clip 18 at two different positions in the X-axis direction. Accordingly, if the lamp clip 18 is arranged in the second orientation, the arrangement of the mounting portions 30, 31 is at least different in the X-axis direction from the first orientation. The mounting portions 30, 31 that are not arranged in predetermined positions do not fit together with the mounting through holes 32, 33, and cannot be passed into the mounting through holes 32, 33. In the present embodiment, two of the three mounting portions 30, 31 and two of the three mounting through holes 32, 33 that are arranged in substantially the same position in the X-axis direction are referred to as first mounting portions 30 and first mounting through holes 32, respectively. One mounting portion 30 and one mounting through hole 32 that are arranged at a different position from the two first mounting portions 30 and first mounting through holes 32 in the X-axis direction are referred to as a second mounting portion 31 and a second mounting through hole 33, respectively. The distance D between the first mounting portion 30 and the second mounting portion 31 in the X-axis direction is equal to the distance D between the first mounting through hole 32 and the second mounting through hole 33. Further, the mounting portions 30, 31 and the mounting through holes 32, 33 are not arranged on a straight line. Hereinafter, the arrangement of the mounting portions 30, 31 will be described in detail. The arrangement of the mounting through holes 32, 33 is the same as the mounting portions 30, 31 and will not be explained.

As illustrated in FIG. 5 and FIG. 6, the two first mounting portions 30 are arranged in a middle portion of the main body 27 in the X-axis direction, which is the width direction (the short-side direction) of the main body 27. The two first mounting portions 30 are adjacent to each other in the Y-axis direction of the main body 27. One of the first mounting portions 30 is arranged on a middle portion of the main body 27 in the length direction (the Y-axis direction) and the other one is arranged on an end portion of the main body 27 in the length direction. The first mounting portion 30 on the middle portion is arranged at substantially the center of the main body in the width direction (the X-axis direction) and the length direction (the Y-axis direction). In other words, the first mounting portion 30 on the middle portion is arranged concentrically with the main body 27 so as to overlap with the support pin 29 provided on a front surface in a plan view. On the other hand, the first mounting portion 30 on the end portion is arranged on an upper side of the first mounting portion 30 on the middle portion of the main body 27 in FIG. 5 and FIG. 6. The distance between the two first mounting portions 30 is equal to the distance between the support pin 29 and the lamp gripping portion 28. The first mounting portion 30 on the end portion is arranged so as to overlap with the lamp gripping portion 28 provided on the front surface of the main body 27 in a plan view.

As illustrated in FIG. 5 and FIG. 6, one second mounting portion 31 is arranged at a position away in the X-axis direction from the middle portion (the first mounting portion 30) in the width direction of the main body 27, that is, at an eccentric position. Specifically, the second mounting portion 31 is arranged on the right side of the middle portion in the width direction of the main body 27 in FIG. 5 (the left side in FIG. 6). In other words, the second mounting portion 31 is arranged at a position away from the middle (a rear side) in a direction opposite to the sliding direction in which the lamp clip 18 is slid to be mounted on the chassis 14. The distance D between the first mounting portion 30 and the second mounting portion 31 in the X-axis direction is about the half the width of the main body 27. The second mounting portion 31 is arranged on the end portion of the main body 27 in the Y-axis direction. Specifically, the second mounting portion 31 is arranged on the lower side of the first mounting portion 30 that is arranged on the middle portion of the main body 27 in FIG. 5 and FIG. 6. The distance in the Y-axis direction between the second mounting portion 31 and the first mounting portion is substantially equal to the distance between the support pin 20 and the lamp gripping portion 28. Accordingly, the distance in the Y-axis direction between the second mounting portion 31 and the first mounting portion 30 on the middle portion is substantially equal to the distance between the first mounting portion 30 on the end portion and the first mounting portion 30 on the middle portion. In other words, the mounting portions 30, 31 are equally spaced apart from each other in the Y-axis direction. The second mounting portion 31 is arranged on substantially the same position in the Y-axis direction as the lamp gripping portion 28 provided on the front surface, but on the rear side of the lamp gripping portion 28 in the X-axis direction.

As described above, two first mounting portions 30 and one second mounting portion 31 are asymmetrically arranged with respect to the center point BC of the main body 27. In addition, two first mounting through holes 32 and one second mounting through hole 33 are asymmetrically arranged in the same manner so as to fit together with the mounting portions 30, 31. With this configuration, when the lamp clip 18 is in the first orientation, the mounting portions 30, 31 fit together with the corresponding mounting through holes 32, 33 (FIG. 11). However, when the lamp clip 18 is in the second orientation (the orientation in which the main body 17 is turned 180 degrees around the center point BC from the first orientation), the first mounting portion 30 and the second mounting portion 31 on each end portion are in a positional relation in the Y-axis direction opposite to the first orientation (FIG. 13). Accordingly, the orientation of the lamp clip 18, i.e., whether in the first orientation or the second orientation, can be easily recognized by visually checking the positional relation between the first mounting portion 30 and the second mounting portion 31 on each end portion. Further, if an operator tries to mount the lamp clip 18 in the second orientation on the chassis 14, the first mounting portions 30 on each end portion and the second mounting portion 31 do not fit the first mounting through hole 32 and the second mounting through hole 33, respectively. Thus, the mounting portions 30, 31 cannot be passed into the mounting through holes 31, 32.

As illustrated in FIG. 5, FIG. 6, and FIG. 9, the width (the dimension in the X-axis direction) of the main body 27 is smaller than the maximum outer diameter of the mounting through holes 32, 33 (the total of the diameters of the large diameter portion 32a, 33a and the small diameter portion 32b, 33b, and the length of the connecting portion 32c, 33). The entire of each of the mounting through holes 32, 33 cannot be covered with the main body 27 when the lamp clip 18 is mounted. To cover the mounting through holes 32, 33, in the present embodiment, three extended portions 39, 40 are provided so as to extend from parts of the main body 27. The extended portions 39, 40 are arranged on rear portions of the main body 27 so as to correspond to the mounting portions 30, 31 in the Y-axis direction. The extended portions 39, 40 each have a plate shape and extend to the rear side, i.e., in the direction opposite to the sliding direction for mounting. The length of each of the extended portions 39, 40 extending from the main body 27 (the dimension in the X-axis direction) is at least larger than the difference between the width of the main body 27 and the maximum outer diameter of the mounting through hole 32, 33. The length of each of the extended portions 39, 40 extending from the main body 27 is substantially equal to or larger than the sliding distance at the time of mounting and detaching of the lamp clip 18. The width (the dimension in the Y-axis direction) of the extended portions 39, 40 is larger than the diameter of the large diameter portion 32a, 33a of the mounting through hole 32, 33. The extended portions 39, 40 have the same width. With this configuration, the mounting through holes 32, 33 are entirely closed with the main body 27 and the extended portions 39, 40 when the lamp clip 18 is mounted.

As illustrated in FIG. 5 and FIG. 6, the length of two of the three extended portions 39, 40 extending from the main body 27 (the dimension in the X-axis direction) is different from the other one of the three extended portions 39, 40. The three extended portions 39, 40 are arranged so as to asymmetrically extend from the main body 17. In the present embodiment, two of the three extended portions 39, 40 having the same length are referred to as a first extended portion 39 and one of the three extended portions 39, 40 having a different length from the first extended portion 39 is referred to as a second extended portion 40. The first extended portions 39 are arranged on the main body 27 so as to substantially correspond to the first mounting portions 30 in the Y-axis direction. The first mounting portions 30 and the first extended portions 39 are linearly arranged along the X-axis direction. The second extended portion 40 is arranged on the main body 28 so as to substantially correspond to the second mounting portions 31 in the Y-axis direction. The second mounting portions 31 and the second extended portions 40 are linearly arranged along the X-axis direction. The length of the second extended portion 40 extending from the main body is larger than the length of the first extended portion 39. The difference in the length between the second extended portion 40 and the first extended portion 39 is substantially equal to the distance in the X-axis direction between the first mounting portion 30 and the second mounting portion 31. In other words, the second extended portion 40 has a larger length than the first extended portion 39 by a distance between the first mounting portion 30 and the second mounting portion 31 arranged on a more rear side than the first mounting portion 30. As described above, the three extended portions 39, 40 are asymmetrically arranged. Thus, depending on the orientation of the lamp clip 18, i.e., whether the lamp clip 18 is in the first orientation or the second orientation, the first extended portion 39 and the second extended portion 40 on each end portion are in different positional relations in the Y-axis direction (FIG. 11 and FIG. 13). Accordingly, by visually checking the positional relation between the first extended portion 39 and the second extended portion 40 on each end portion, an operator can easily recognize whether the lamp clip 18 is in the first orientation or the second orientation. Further, the position of the extended portions 39, 40 will be opposite in the X-axis direction of the main body 27 depending on whether the lamp clip 18 is in the first orientation or the second orientation.

The present embodiment has the above-described structure, and an operation thereof will be described. The liquid crystal panel 11 and the backlight unit 12 are separately produced and assembled using the bezel 13 or the like into the liquid crystal display device 10 illustrated in FIG. 3 and FIG. 4. Then, an assembling operation of the backlight unit 12, particularly, the mounting operation of the lamp clip 18 on the chassis 14 will be described in detail.

When the reflection sheet 23 is provided on the inner side of the chassis 14, the insertion holes 34 are positioned so as to correspond to the corresponding mounting through holes 32, 33. Then, each lamp clip 18 is mounted on the chassis 14. An operator grasps the support pin 29 and positions the main body 27 such that the long-side direction thereof matches the short-side direction of the chassis 14. Then, the operator passes the mounting portions 30, 31 through the mounting through holes 32, 33 of the chassis 14. At this time, the lamp clip 18 may be in any one of two orientations, a first orientation and a second orientation. In the first orientation, the extended portions 39, 40 of the lamp clip 18 are oriented to the rear side. In the second orientation, the extended portions 39, 40 are turned 180 degrees around the center point BC of the main body 27 from the first orientation and oriented to the front side. However, in the present embodiment, the lamp clip 18 can be mounted only when the mounting portions 30, 31 and the mounting through holes 32, 33 are in the first orientation. The lamp clip 18 in the first orientation will be described first.

When the lamp clip 18 is in the first orientation, two first mounting portions 30 and one second mounting portion 31 fit together with two first mounting through holes 32 and one second mounting through hole 33, respectively, in the X-direction and the Y-axis direction. As illustrated in FIG. 11, by pressing the lamp clip 18 in this orientation into the chassis 14, the protrusions 30b, 31b of the mounting portions 30, 31 are passed through the respective large diameter portions 32a, 33a of the mounting through holes 32, 33. At this time, the mounting portions 30, 31 are concentrically with the large diameter portions 32a, 33a of the mounting through holes 32, 33, respectively. The support pin 29 to be manipulated by an operator overlaps concentrically with the first mounting portion 30 on the middle portion in a plan view. This highly facilitates the insertion operation. At this time, the entire of the second mounting through hole 32 is overlapped with the main body 27 and the second extended portion 40, the large diameter portion 32a of the first mounting through hole 32 is overlapped with the main body 27, and the small diameter portion 32b of the first mounting through hole 32 is exposed.

Then, when the protrusions 30b, 31b of the mounting portions 30, 21 that are passed through the insertion holes 34 and the mounting through holes 32, 33 are stuck out from the rear side of the chassis 14, the lamp clip 18 is slid to the front side along the X-axis direction (toward the left side in FIG. 11). Then, the base portions 30a, 31a enter into the small diameter portions 32b, 33b through the connecting portions 32c, 33c from the large diameter portions 32a, 33a, and the protrusions 30b, 31b are arranged so as to face the rear side of the edges of the mounting through holes 32, 33 of the chassis 14. When the lamp clip 18 is moved to a predetermined position, as illustrated in FIG. 12, the mounting portions 30, 31 are arranged concentrically with the small diameter portions 32b, 33b. At this time, as illustrated in FIG. 10, the edges (especially, edges of the small diameter portions 32b, 33b and the connecting portions 32c, 33c) are sandwiched between the protrusions 30b, 31b of the mounting portions 30, 31. Accordingly, the mounting orientation of the lamp clip 18 on the chassis 14 and the reflection sheet 23 can be maintained. As illustrated in FIG. 12, in this mounting orientation, the entire of each of the mounting through holes 32, 33 and the insertion holes 34 is closed with the main body 27 and the extended portions 39, 40 of the lamp clip 18, and not opened or exposed to the inside of the chassis 14. Further, in the mounting orientation, the edges of the mounting through holes 32, 33 are sandwiched with the flange-like protrusions 30b, 31b included in the mounting portions 30, 31. That is, sufficient amount of area is sandwiched, and thus, high holding power can be obtained.

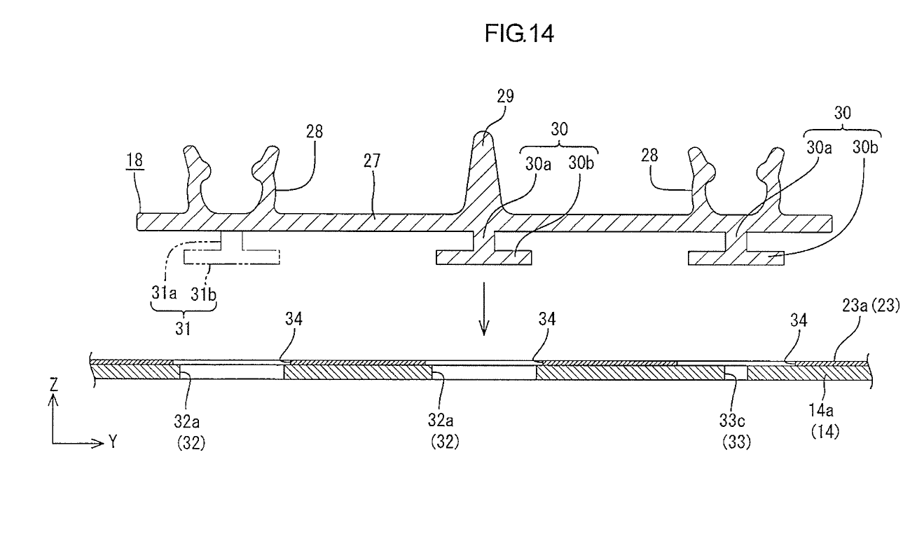

Next, the lamp clip 18 in the second orientation in which the lamp clip 18 is in an orientation opposite to the first orientation in a front to back direction will be explained. As illustrated in FIG. 13, when the lamp clip 18 in the second orientation is attempted to be arranged such that the mounting portions 30, 31 correspond to the mounting through holes 32, 33 in the Y-axis direction, the first mounting portion 30 on the middle portion can correspond to the first mounting through hole 32 on the middle portion, but the first mounting portion 30 and the second mounting portion 31 on each end portion cannot correspond to the first mounting through hole 32 and the second mounting through hole 33 on each end portion in the X-axis direction. Specifically, the first mounting portion 30 on one end can correspond to the second mounting through hole 33 on the one end in the Y-axis direction, but not in the X-axis direction. As illustrated in FIG. 13 and FIG. 14, the protrusion 30b of the first mounting portion 30 on the one end interferes with the edge of the small diameter portion 33b and the connecting portion 33c of the second mounting through hole 33, and the protrusion 31b of the second mounting portion 31 interferes with the small diameter portion 32b and the connecting portion 32c of the first mounting through hole 32 on the other end. Thus, the lamp clip 18 in the second orientation cannot be mounted on the chassis 14. In such a case, an operator should set the lamp clip 18 in the first orientation and begin the mounting operation again.

The mounting portions 30, 31 are not allowed to be passed into the mounting through holes 32, 33 as described above, and thus the lamp clip 18 in the second orientation cannot be mounted. However, in the present embodiment, an operator can easily recognize the orientation of the lamp clip 18 before the mounting operation. Specifically, the three mounting portions 30, 31 of the lamp clip 18 are asymmetrically arranged at two positions in the X-axis direction such that the first mounting portion 30 and the second mounting portion 31 on each end portion in the Y-axis direction are positioned in an opposite manner depending on whether the lamp clip 18 is in the first orientation or the second orientation. This enables an operator to easily recognize whether the lamp clip 18 is in the first orientation or the second orientation before the mounting operation by visually checking the positional relation between the first mounting portion 30 and the second mounting portion 31 on each end portion. Further, in the present embodiment, the three extended portions 39, 40 are arranged in the same manner as the mounting portions 30, 31 and eccentrically arranged with respect to the main body 27 in the X-axis direction. With this configuration, an operator is less likely to try to mount the lamp clip 18 in the second orientation on the chassis 14, and thus the mounting operation can be facilitated. Further, the mounting portions 30, 31 are arranged in different two positions in the X-axis direction and are equally spaced apart from each other in the Y-axis direction. Accordingly, the positional relation between the first mounting portion 30 and the second mounting portion 31 in the X-axis direction can be easily recognized.

A problem that may occur when the lamp clip 18 is allowed to be mounted in the second orientation will be explained with reference to FIG. 13. If the mounting portions 30, 31 of the lamp clip 18 in the second orientation are passed into the mounting through holes 32, 33 and slid toward the front side, the large diameter portions 32a, 33a of the mounting through holes 32, 33 are not covered with the body member 27 and the extended portions 39, 40, and thus the large diameter portions 32a, 33a may be exposed to the inside of the chassis 14. If the liquid crystal display device 10 is assembled with the lamp clip 18 mounted in this way and the cold cathode fluorescent tube 17 is lit to display an image on the liquid crystal panel 11, the exposed parts of the large diameter portions 32a, 33a of the mounting through holes 32, 33 may be recognized as dark portions, or the light may leak through the exposed parts of the large diameter portions 32a, 33a of the mounting through holes 32, 33 to the rear side of the chassis 14. According to the present embodiment, the lamp clip 18 is not mistakenly mounted in the second orientation in which the lamp clip 18 does not close the mounting through holes 32, 33, but always mounted in the first orientation in which the lamp clip 18 properly closes all of the mounting through holes 32, 33. Thus, the dark portion does not appear on the liquid crystal panel 11 and the leakage of light does not occur.

After the lamp clips 18 are mounted on the chassis in the first orientation as above, the cold cathode fluorescent tubes 17 are housed in the chassis 14 so as to be held by the lamp gripping portions 28. Then, the holder 20 is attached. Subsequently, the diffuser plate 15a and the optical sheets 15b are laminated to assemble the backlight unit 12, and the liquid crystal panel 11 is arranged on the front side of the backlight unit 12. Then, the bezel 13 is attached. Consequently, the liquid crystal display device 10 illustrated in FIG. 3 and FIG. 4 is assembled.

As explained above, the backlight unit 12 according to the present embodiment includes the cold cathode fluorescent tube 17 as the linear light source, the chassis 14 housing the linear cold cathode fluorescent tube 17, and the lamp clip 18. The chassis 14 includes the at least three mounting through holes 32, 33. At least one of the mounting through holes 32, 33 is arranged on a first line and at least one of the mounting through holes 32, 33 is arranged on a second line. The first line and the second line separately extend in a direction substantially perpendicular to the axial direction of the cold cathode fluorescent tube 17 (the X-axis direction), whereby the mounting through holes 32, 33 are asymmetrically arranged. The lamp clip 18 includes the main body 27 attached to the chassis 14, the light source gripping portion 28 provided on the main body 27, and the at least three mounting portions 30, 31 protruding from the main body 27 to the chassis 14. The light source gripping portion 28 is capable of gripping the cold cathode fluorescent tube 17. At least one of the mounting portions 30, 31 is arranged on the first line and at least one of the mounting portions 30, 31 is arranged on the second line, whereby the mounting portions 30, 31 are asymmetrically arranged. The mounting portions 30, 31 on the first line and the second line are passed through the mounting through holes 32, 33 on the first line and the second line, respectively, such that the edge of each mounting through hole 32, 33 is sandwiched between the corresponding mounting portion 30, 31 and the main body 27.

In this configuration, if an operator tries to mount the lamp clip 18 in the improper orientation on the chassis 14, not all of the at least three mounting portions 30, 31 asymmetrically arranged in two different positions in the axial direction of the cold cathode fluorescent tube 17 fit together with the corresponding mounting through holes 32, 33. This does not allow the lamp clip 18 to be mounted, and then the operator realizes that the lamp clip 18 is not in the predetermined orientation. Then, the operator sets the lamp clip 18 in the predetermined orientation and begins the mounting operation again.

The mounting portions 30, 31 and the corresponding mounting through holes 32, 33 are asymmetrically arranged at at least two different positions in the axial direction of the cold cathode fluorescent tube 17. Accordingly, the operator can easily recognize the orientation of the lamp clip 18 by visually checking the mounting portions 30, 31 before the mounting operation. With this configuration, the operator is less likely to try to mount the lamp clip 18 on the chassis 14 in the improper orientation. This facilitates the mounting operation. According to the present embodiment, the lamp clip 18 is prevented from being mounted in an orientation different from a predetermined orientation and the mounting operation can be facilitated.

The mounting portions 30, 31 include at least two first mounting portions 30 arranged on the first line extending in the direction substantially perpendicular to the axial direction of the cold cathode fluorescent tube 17 and at least one second mounting portion 31 arranged on the second line extending separately from the first line in the direction substantially perpendicular to the axial direction of the cold cathode fluorescent tube 17. The mounting through holes 32, 33 include at least two first mounting through holes 32 arranged on the first line extending in the direction substantially perpendicular to the axial direction of the linear light source and at least one second mounting through hole 33 arranged on the second line extending separately from the first line in the direction substantially perpendicular to the axial direction of the cold cathode fluorescent tube 17. In this configuration, the at least two first mounting portions 30 and the at least two first mounting through holes 32 are arranged at substantially the same position in the axial direction of the cold cathode fluorescent tube 17, and the at least one second mounting portion 31 and the at least one second mounting through hole 33 are arranged at the position different from the position of the first mounting portions 30 and the first mounting through holes 32 in the axial direction of the cold cathode fluorescent tube 17. Accordingly, the orientation of the lamp clip 18 can be easily recognized compared with mounting portions that are all positioned at different positions in the axial direction of the cold cathode fluorescent tube 17. This further facilitates the mounting operation.

The first mounting portions 30 are arranged adjacent to each other on the main body 27 in the direction substantially perpendicular to the axial direction of the cold cathode fluorescent tube 17 (the Y-axis direction). With this configuration, the orientation of the lamp clip 18 can be easily recognized by visually checking the first mounting portions 30 arranged adjacent to each other.

The second mounting portion 31 is arranged on the end portion of the main body 27 in the direction substantially perpendicular to the axial direction of the cold cathode fluorescent tube 17. With this configuration, the orientation of the lamp clip 18 can be easily recognized by visually checking the second mounting portion 31 arranged on the end portion of the main body 27.

The first mounting portions 30 are each arranged on the middle portion and the one end portion of the main body 27 in the direction substantially perpendicular to the axial direction of the cold cathode fluorescent tube 17, and the second mounting portion 31 is arranged on the other end portion of the main body 27 in the direction substantially perpendicular to the axial direction of the cold cathode fluorescent tube 17. With this configuration, the orientation of the lamp clip 18 can be easily recognized by a positional relation between the first mounting portions 30 and the second mounting portion 31.

The first mounting portions 30 and the second mounting portion 31 are arranged equally spaced apart from each other in the direction substantially perpendicular to the axial direction of the cold cathode fluorescent tube 17. With this configuration, the positional relation between the first mounting portions 30 and the second mounting portion 31 in the axial direction of the cold cathode fluorescent tube 17 can be more accurately recognized compared with the first mounting portions and the second mounting portion that are arranged to be unequally spaced apart from each other. Thus, the orientation of the lamp clip 18 can be further easily recognized.

The lamp gripping portion 28 provided on the main body 27 includes a plurality of light source gripping portions 28. At least one of the light source gripping portions 28 is arranged on the first line on which the first mounting portions 30 are arranged. With this configuration, the size of the main body 27 can be made smaller in the axial direction of the cold cathode fluorescent tube 17 compared with the lamp gripping portions that are all arranged at different positions than the first mounting portions 30 in the axial direction of the cold cathode fluorescent tube 17.

One of the light source gripping portions 28 arranged on the first line on which the first mounting portions 30 are arranged is located at the position substantially identical with the position of the first mounting portions 30 on the first line. With this configuration, the size of the main body 27 can be made smaller in the axial direction of the cold cathode fluorescent tube 17 compared with the lamp gripping portions that are all arranged at different positions than the first mounting portions 30 in the direction substantially perpendicular to the axial direction of the cold cathode fluorescent tube 17.

One of the at least one of the lamp gripping portions 18 arranged on the first line on which the first mounting portions 30 are arranged overlaps with one of the first mounting portions 30 in a plan view. With this configuration, the position of the light source gripping portion 18 can be easily recognized by visually checking the first mounting portion 30. Conversely, the position of the first mounting portion 30 can be easily recognized by visually checking the light source gripping portion 18.

One of the at least one of the light source gripping portions 18 is arranged on the first line at the position substantially identical with the position of the second mounting portion 31 in the direction substantially perpendicular to the axial direction of the cold cathode fluorescent tube 17. With this configuration, the size of the main body 27 can be made smaller in the axial direction of the cold cathode fluorescent tube 17 compared with the light source gripping portions 18 that are all arranged at different positions than the second mounting portion 31 in the direction substantially perpendicular to the axial direction of the cold cathode fluorescent tube 17.

The lamp clip 18 is configured such that the edge of each of the mounting through holes 32, 33 is sandwiched between each of the mounting portions 30, 31 and the main body 27 when the lamp clip 18 is slid in the axial direction of the cold cathode fluorescent tube 17 with the mounting portions 30, 31 being passed through the corresponding mounting through holes 32, 33. With this configuration, even if the amount of sliding of the lamp clip 18 is too much or too less, a change in a positional relation between the lamp gripping portion 28 and the cold cathode fluorescent tube 17 in a direction intersecting with the axial direction of the cold cathode fluorescent tube 17 (the Y-axis direction) is less likely to occur. Accordingly, when the cold cathode fluorescent tube 17 is gripped by the lamp gripping portion 28, excessive force is less likely to act on the cold cathode fluorescent tube 17, and thus the cold cathode fluorescent tube 17 can be stably held.

Each of the mounting through holes 32, 33 include the large diameter portion 32a, 33a having a relatively large diameter, the small diameter portion 32b, 33b having a smaller diameter than the large diameter portion 32a, 33a, and the connecting portion 32c, 33c that connects the large diameter portion 32a, 33a and the small diameter portion 32b, 33b. The small diameter portion 32b, 33b having an edge is sandwiched between the mounting portion 30, 31 and the main body 27. In this configuration, when the lamp clip 18 is slid after the mounting portions 30, 31 are passed into the large diameter portions 32a, 33a of the corresponding mounting through holes 32, 33, the mounting portions 30, 31 are passed into the small diameter portions 32b, 33b through the connecting portions 32c, 33c and the edge of each of the small diameter portions 32b, 33b is sandwiched between the mounting portion 30, 31 and the main body 27. Accordingly, the lamp clip 18 can be stably mounted on the chassis 14.

The lamp clip 18 further includes the extended portions 39, 40 extending from the main body 27 in the direction opposite to a direction in which the lamp clip 18 is slid for mounting. A part of each of the extended portions 39, 40 overlaps with the large diameter portion 32a, 33a in a plan view with the mounting portions 30, 31 being in the small diameter portions 33a, 33b. In this configuration, when the lamp clip 18 is slid after the mounting portions 30, 31 are passed into the large diameter portions 32a, 33a of the mounting through holes 32, 33, the mounting portions 30, 31 are passed into the small diameter portions 32b, 33b and the edge of each of the small diameter portions 32b, 33b is sandwiched between the mounting portion 30, 31 and the main body 27. Further, at least a part of the extended portion 39, 40 overlaps with the large diameter portion 32a, 33a in a plan view. As described above, the large diameter portions 32a, 33a are covered with the extended portion 39, 40 and not exposed. Further, the extended portion 39, 40 only protrudes from parts of the main body 27, and thus the lamp clip 18 can have a small surface area compared with the lamp clip having a main body having a large width over the entire length thereof. Thus, the brightness unevenness is less likely to occur and a material cost can be reduced.

The extended portions 39, 40 each have the width larger than the diameter of the large diameter portion 32a, 33a. With this configuration, each of the extended portions 39, 40 can cover the entire area of each of the large diameter portions 32a, 33a.

The extended portions 39, 40 include at least three extended portions 39, 40 arranged corresponding to the mounting portions 30, 31. The extended portions 39, 40 have two different lengths measured in the axial direction of the cold cathode fluorescent tube 17 and asymmetrically arranged. In this configuration, in addition to the mounting portions 30, 31, the extended portions 39, 40 are asymmetrically arranged. Thus, the orientation of the lamp clip 18 can be further easily recognized. Further, compared with extended portions all of which have the same protruding length, the lamp clip 18 having the extended portion 39, 40 of this configuration can have a smaller surface area. Thus, the uneven brightness is less likely to occur and a material cost can be reduced.

A plurality of lamp gripping portions 28 are provided on the main body 27 and are arranged at the positions substantially aligned in the direction substantially perpendicular to the axial direction of the cold cathode fluorescent tube 17. With this configuration, the cold cathode fluorescent tube 17 is gripped by the lamp gripping portions 28 at substantially the same position in the axial direction. Thus, the cold cathode fluorescent tube 17 can be stably held. When the lamp gripping portions 28 are arranged in the above manner, the orientation of the lamp clip 18 cannot be easily recognized by visually checking the lamp gripping portion 28, but the orientation of the lamp clip 18 can be easily recognized by visually checking the mounting portions 30, 31. Accordingly, the mounting operation can be sufficiently facilitated.

The backlight unit 12 further includes the optical member 15a, 15b arranged on the light exit side of the cold cathode fluorescent tube 17, and the support pin 29 provided on the main body 27 to support the optical member 15a, 15b. With this configuration, the optical member 15a, 15b can be supported by the support pin 29, and thus, the positional relation between the cold cathode fluorescent tube 17 and the optical member 15a, 15b can be maintained. This enables an operator to mount the lamp clip 18 on the chassis 14 by manipulating the support pin 29 and facilitates the mounting operation.

The support pin 29 and the lamp gripping portions 28 are arranged at the positions substantially aligned in the direction substantially perpendicular to the axial direction of the cold cathode fluorescent tube 17. In this configuration, the orientation of the lamp clip 18 cannot be easily recognized by visually checking the support pin 29 and the lamp gripping portion 28, but the orientation of the lamp clip 18 can be easily recognized by visually checking the mounting portions 30, 31. Accordingly, the mounting operation can be sufficiently facilitated.

The support pin 29 and the lamp gripping portions 28 are equally spaced apart from each other in the direction substantially perpendicular to the axial direction of the cold cathode fluorescent tube 17. In this configuration, the orientation of the lamp clip 18 cannot be easily recognized by visually checking the support pin 29 and the lamp gripping portion 28, but the orientation of the lamp clip 18 can be easily recognized by visually checking the mounting portions 30, 31. Accordingly, the mounting operation can be sufficiently facilitated.

The lamp gripping portion 28 are symmetrically arranged about the support pin 29. In this configuration, the orientation of the lamp clip 18 cannot be easily recognized by visually checking the support pin 29 and the lamp gripping portion 28, but the orientation of the lamp clip 18 can be easily recognized by visually checking the mounting portions 30, 31. Accordingly, the mounting operation can be sufficiently facilitated.

The support pin 29 is arranged at the middle portion of the main body 27. Further, the at least two lamp gripping portions 28 are arranged at the end portions of the main body 27 such that the support pin 29 is located therebetween. With this configuration, the support pin 29 can be easily manipulated to mount the lamp clip 18 on the chassis 14 compared with the support pin 29 eccentrically provided at a position closer to the edge of the main body 27. This facilitates the mounting operation.

The support pin 29 is arranged at substantially the center BC of the main body 27. With this configuration, the support pin 29 can be further easily manipulated to mount the lamp clip 18 on the chassis 14. This facilitates the mounting operation.

One of the mounting portions 30, 31 overlaps with the support pin 29 in a plan view. With this configuration, at the time of insertion of the mounting portion 30, 31 into the corresponding mounting through holes 32, 33, the support pin 29 that is arranged at a position overlapping with one of the mounting portions 30, 31 can be manipulated. Thus, the insertion operation can be further facilitated.

One of the mounting portions 30, 31 is concentrically arranged with the support pin 29. With this configuration, at the time of the insertion of the mounting portions 30, 31 into the corresponding mounting through holes 32, 33, the support pin 29 that is concentrically arranged with the one of the mounting portions 30, 31 can be manipulated. Thus, the insertion operation can be further facilitated.

The lamp clips 18 are arranged in the chassis 44 in a zigzag pattern. With this configuration, the lamp clip 18 arranged in the chassis 14 is less likely to be recognized as a dark portion, and thus brightness unevenness is less likely to occur.

The cold cathode fluorescent tube is used as a linear light source. With this configuration, a service life of the light source can be longer and control of light can be easily performed.

### Second Embodiment

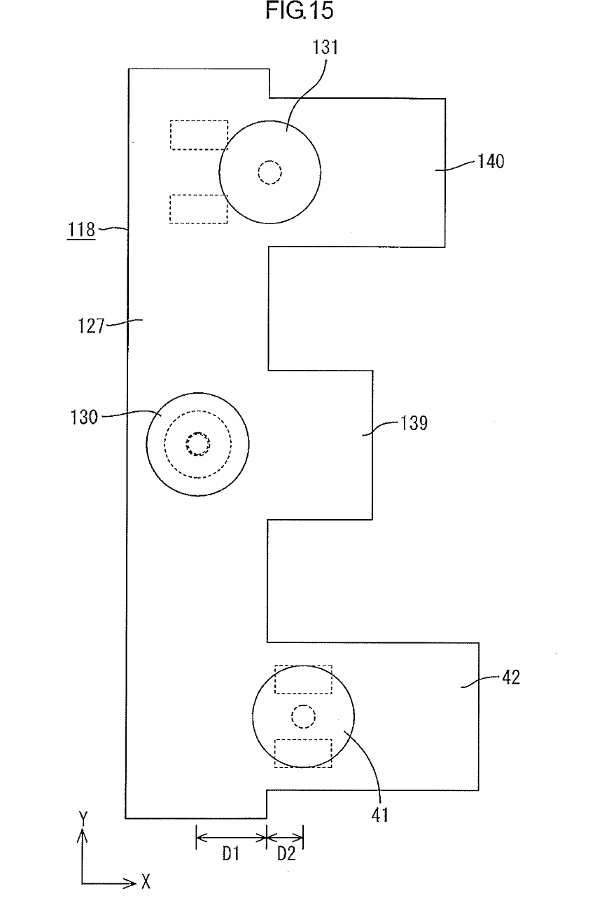

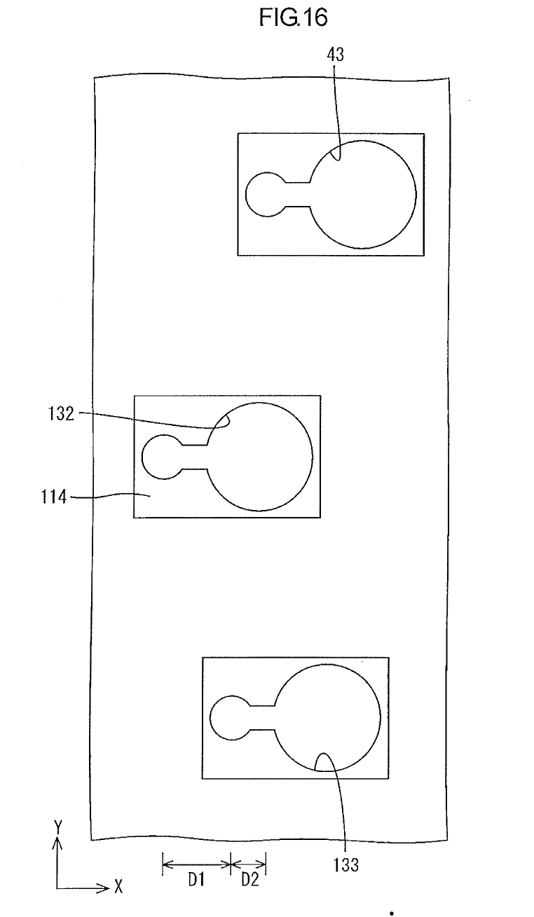

The second embodiment of the present invention will be explained with reference to FIG. 15 or FIG. 16. In the second embodiment, mounting portions 130, 131, 41 are each arranged at different positions in the X-axis direction. The other constructions, advantages, and effects same as those in the first embodiment will not be explained.

As illustrated in FIG. 15, a lamp clip 118 according to the present embodiment includes first mounting portion 130, second mounting portion 131, and third mounting portion 41. The first mounting portion 130 is arranged on a middle portion of a main body 127 in the Y-axis direction. The second mounting portion 131 is arranged on one end portion of the main body 127 in the Y-axis direction so as to be on a more rear side than the first mounting portion 30 in the X-axis direction (a side opposite to the sliding direction at the time of mounting). The third mounting portion 41 is arranged on the other end portion of the main body 127 in the Y-axis direction so as to be on a more rear side than the second mounting portion 131 in the X-axis direction. A distance D1 between the first mounting portion 130 and the second mounting portion 131 in the X-axis direction is larger than a distance D2 between the second mounting portion 131 and the third mounting portion 41 in the X-axis direction. From a rear portion of the main body 127, a first extended portion 139 corresponding to the first mounting portion 130, a second extended portion 140 corresponding to the second mounting portion 131, and a third extended portion 42 corresponding to the third mounting portion 41 extend. The third extended portion 42 has the longest length, followed by the second extended portion 140, and the first extended portion 139. As illustrated in FIG. 16, in the chassis 114, a first mounting through hole 132, a second mounting through hole 133, and a third mounting through hole 43 are provided. The first mounting through hole 132 corresponds to the first mounting portion 130 of a lamp clip 118 in the first orientation. The second mounting through hole 133 corresponds to the second mounting portion 131 and is arranged on a more rear side than the first mounting through hole 132 in the X-axis direction. The third mounting through hole 43 corresponding to the third mounting portion 41 and is arranged on a more rear side than the second mounting through hole 133 in the X-axis direction. The positional relation of the mounting through holes 132, 133, 43 in the X-axis direction is the same as that of the mounting portions 130, 131, 41.

As described above, the mounting portions 130, 131, 41 are asymmetrically arranged and the mounting through holes 132, 133, 43 are asymmetrically arranged. If the lamp clip 118 is set in the second orientation that is different from the first orientation, like the above-described first embodiment, the lamp clip 118 cannot be mounted. In addition to that, the lamp clip 118 can be easily recognized whether it is in the first orientation or the second orientation by visually checking the positional relation between the mounting portions 130, 131, 41 before the mounting operation.

### Third Embodiment

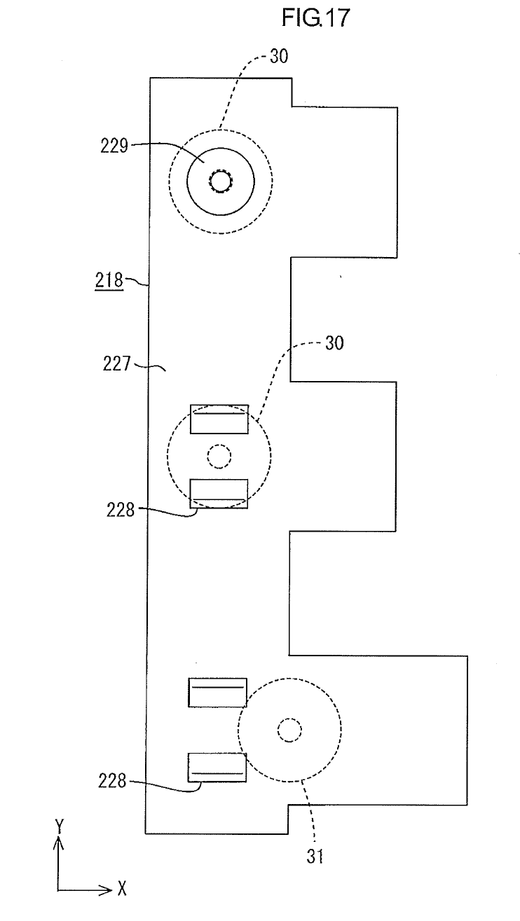

The third embodiment of the present invention will be explained with reference to FIG. 17. In the third embodiment, an arrangement of a lamp gripping portion 228 and a support pin 229 is different from that of the first embodiment. The other constructions, advantages, and effects same as those in the first embodiment described above will not be explained.

As illustrated in FIG. 17, a lamp clip 218 according to the present embodiment includes lamp gripping portions 228 and a support pin 229. The lamp gripping portions 228 are each arranged on a middle portion and one end portion of amain body 227 in the Y-axis direction. The support pin 229 is arranged on the other end portion of the main body 227 in the Y-axis direction. In other words, the support pin 229 is eccentrically arranged on the main body 227 in the Y-axis direction. Even in the lamp clip 218 including the lamp gripping portions 228 and the support pin 229 arranged in this way, the mounting portions 30, 31 are asymmetrically arranged in different two positions in the X-axis direction.

### Fourth Embodiment

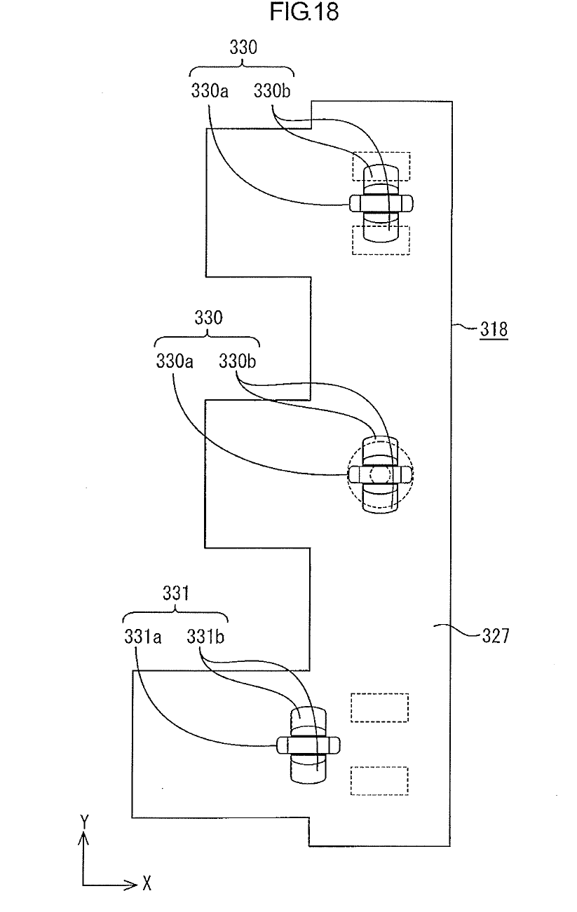

The fourth embodiment of the present invention will be explained with reference to FIG. 18 to FIG. 20. In the fourth embodiment, amounting structure of a lamp clip 318 in a chassis 314 is different from that of the first embodiment. The other constructions, advantages, and effects same as those in the first embodiment described above will not be explained.

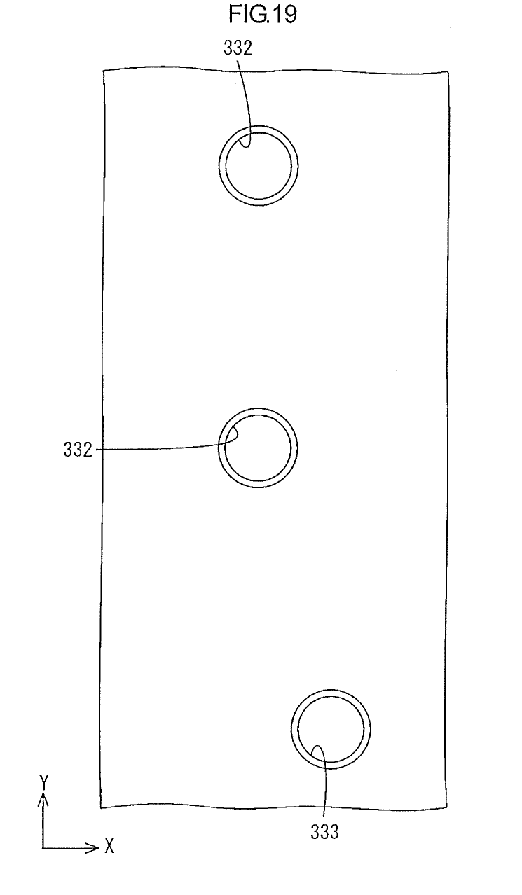

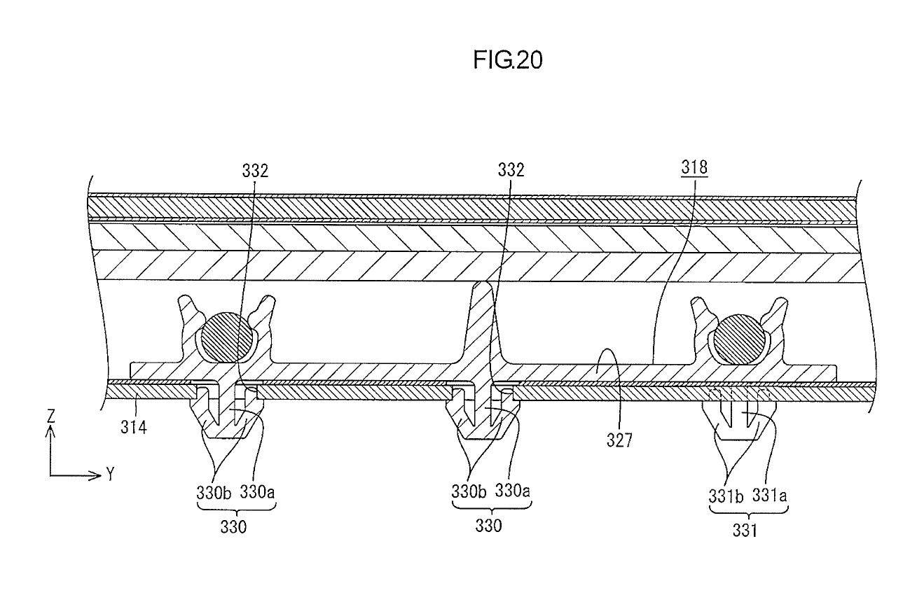

As illustrated in FIG. 18 and FIG. 20, a lamp clip 318 of the present embodiment includes mounting portions 330, 331. The mounting portions 330, 331 each include a base portion 330a, 331 and a pair of protrusions 330b, 331b. The base portion 330a, 331a protrudes from a rear surface of a main body 327, and the pair of protrusions 330b, 331b protrudes from the tip end of the base portion 330a, 331a toward the main body 327 while facing the base portion 330a, 331a. The protrusions 330b, 331b are cantilevered and elastically deformable in a direction closer to the base portions 330a, 331a. The protrusions 330b, 331b each have a stepped locking surface at the tip end portion thereof. As illustrated in FIG. 19 and FIG. 20, the chassis 314 includes mounting through holes 332, 333 each having a circular shape in a plan view. The diameter of each of the mounting through holes 332, 333 is substantially equal to a distance between the locking surfaces of the pair of protrusions 330b, 331b.

By pressing the lamp clip 318 into the chassis 314 in the Z-axis direction from the front side, the mounting portions 330, 331 are passed into the corresponding mounting through holes 332, 333 and the protrusions 330b, 331b are elastically deformed. Then, when the lamp clip 318 is pressed down to a predetermined depth, the mounting portions 330, 331 are stuck out from the rear side of the chassis 314 and the protrusions 330b, 331b are restored so that the locking surfaces are locked by the edges of the mounting through holes 332, 333 of the chassis 314 from the rear side. Thus, the mounting state of the lamp clip 318 on the chassis 314 is maintained.

### Other Embodiments

The present invention is not limited to the embodiments explained in the above description with reference to the drawings. The following embodiments may be included in the technical scope of the present invention, for example.

(1) The above embodiments including three mounting portions and three mounting through holes are illustrated as examples. However, the technology of the present invention is applicable to a lighting device including at least four mounting portions and at least four mounting through holes. In such a case, the second mounting portion may be arranged on the middle portion in the direction substantially perpendicular to the axial direction of the cold cathode fluorescent tube (the Y-axis direction), that is, the second mounting portion may not be arranged on an end portion of the main body. The second mounting portion is arranged at a different position in the axial direction of the cold cathode fluorescent tube (the X-axis direction) from the first mounting portions arranged at the same position in the X-axis direction.

(2) The at least four mounting portions may include two or more first mounting portions that are arranged at the same position in the axial direction of the cold cathode fluorescent tube (the X-axis direction) and two or more second mounting portions that are arranged at a different position from the first mounting portions in the axial direction of the cold cathode fluorescent tube. The number of first mounting portions may be equal or unequal to the number of second mounting portions. Further, the second mounting portion may be arranged between the first mounting portions such that the first mounting portions are not adjacent to each other.

(3) The at least four mounting portions and the at least four mounting through holes may include three or more kinds of mounting portion and three or more kinds of mounting through hole that are arranged at three or more different positions in the axial direction of the cold cathode fluorescent tube (the X-axis direction).

(4) In the above embodiments, the first mounting portion on the middle portion is concentrically arranged with the main body. However, in the present invention, the center of the first mounting portion on the middle portion may not match with the center of the main body.

(5) In the above embodiments, the distance between the adjacent mounting portions are substantially the same in the direction substantially perpendicular to the axial direction of the cold cathode fluorescent tube (the Y-axis direction). However, in the present invention, the distance between the adjacent mounting portions in the Y-axis direction may be different.

(6) In the above first to third embodiments, the large diameter portion and the small diameter portion included in the mounting through hole are spaced apart from each other in the axial direction of the cold cathode fluorescent tube (the X-axis direction). In other words, the distance between the center of the large diameter portion and the center of the small diameter portion is larger than the total of the diameter of the large diameter portion and the diameter of the small diameter portion. However, in the present intention, the positional relation between the large diameter portion and the small diameter portion in the axial direction of the cold cathode fluorescent tube may be suitably changed. For example, the distance between the center of the large diameter portion and the center of the small diameter portion may be substantially the same as or smaller than the total of the diameter of the large diameter portion and the diameter of the small diameter portion. When the distance between the center of the large diameter portion and the center of the small diameter portion is smaller than the total diameters thereof, the large diameter portion and the small diameter portion partially overlap with each other in a plan view.

(7) In the above embodiments, the first mounting portion on the end portion overlaps with the lamp gripping portion in a plan view. However, the first mounting portion on the end portion may not overlap with the lamp gripping portion.

(8) In the above embodiments, the second mounting portion is not overlapped with the lamp gripping portion in a plan view. However, in the present invention, the second mounting portion may be overlapped with the lamp gripping portion in a plan view.

(9) In the above embodiments, the first mounting portion on the middle portion is concentrically arranged and overlapped with the support pin in a plan view. However, the center of the first mounting portion may not match with the center of the support pin while the first mounting portion is overlapped with the support pin in a plan view. Further, the first mounting portion may not be overlapped with the support pin in a plan view.

(10) In the above embodiments, the two lamp gripping portions are arranged at the same position in the axial direction of the cold cathode fluorescent tube (the X-axis direction). However, in the present invention, the two lamp gripping portions may be arranged at different positions in the X-axis direction. Similarly, the lamp gripping portions and the support pin may be arranged at different positions in the X-axis direction.

(11) In the above embodiment, the number of mounting portions is equal to the total number of lamp gripping portions and support pins. However, the number of mounting portions may not be equal to the total number of lamp gripping portions and support pins. In such a case, the number of mounting portions may be either larger or smaller than the total number of lamp gripping portions and support pins.

(12) In the above embodiments, the lamp clip includes two lamp gripping portions. However, the number of lamp gripping portions may be one or three or more. Further, the number of support pins may be two or more.

(13) In the above first to third embodiments, the lamp clip is slid along the axial direction of the cold cathode fluorescent tube (the X-axis direction). However, according to the technology of the present invention, the lamp clip may be slid along the direction substantially perpendicular to the axial direction of the cold cathode fluorescent tube (the Y-axis direction) or along an oblique direction with respect to the axial direction of the cold cathode fluorescent tube.

(14) In the above embodiments, the axial direction of the cold cathode fluorescent tube matches the long-side direction of the chassis. However, the technology of the present invention is applicable to a lighting device in which the axial direction of the cold cathode fluorescent tube matches the short-side direction of the chassis.

(15) The above embodiments employs the straight-type cold cathode fluorescent tube including an uncurved glass tube. However, the cold cathode fluorescent tube may include a glass tube extending in a U-shape or W-shape. In such a case, the lamp gripping portions included in one lamp clip may grip one cold cathode fluorescent tube.

(16) In the above embodiments, the cold cathode fluorescent tube is used as the linear light source. However, a different type of linear light sources such as a hot cathode tube may be used.

(17) In the above embodiments, the liquid crystal panel and the chassis are arranged in a vertical position such that the short-side direction matches the vertical direction. However, the liquid crystal panel and the chassis are arranged in a vertical position such that the long-side direction matches the vertical direction.

(18) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(19) In the above embodiments, the liquid crystal display device including the liquid crystal panel as a display panel is used. The technology can be applied to display devices including other types of display panels.

(20) In the above embodiments, the television receiver including the tuner is used. However, the technology can be applied to a display device without a tuner.

### EXPLANATION OF SYMBOLS

10: liquid crystal display device (display device), 11: liquid crystal panel (display panel), 12: backlight unit (lighting unit), 14, 114, 314: chassis, 15a: diffuser plate (optical member), 15b: optical sheet (optical member), 17: cold cathode fluorescent tube (linear light source), 18, 118, 218, 318: lamp clip (light source holder), 27, 127, 227, 327: main body, 28, 28: lamp gripping portion (light source gripping portion), 29, 229: support pin (supporting member), 30, 130, 330: first mounting portion (mounting portion), 31, 131, 331: second mounting portion (mounting portion), 32, 132, 332: first mounting through hole (mounting through hole), 33, 133, 333: second mounting through hole (mounting through hole), 32a, 33a: large diameter portion, 32b, 33b: small diameter portion, 32c, 33c: connecting portion, 39, 139: first extended portion (extended portion) 40, 140: second extended portion (extended portion), 41: third mounting portion (mounting portion), 42: third extended portion (extended portion), 43: third mounting through hole (mounting through hole), BC: center point (center), TV: television receiver

1. A lighting device comprising:
a linear light source;
a chassis housing the linear light source, the chassis including at least three mounting through holes, at least one of the mounting through holes being arranged on a first line and at least one of the mounting through holes being arranged on a second line, the first line and the second line being separately extending in a direction substantially perpendicular to an axial direction of the linear light source, whereby the mounting through holes are asymmetrically arranged; and
a light source holder including a main body attached to the chassis, a light source gripping portion provided on the main body, and at least three mounting portions protruding from the main body to the chassis, the light source gripping portion being capable of gripping the linear light source, at least one of the mounting portions being arranged on the first line and at least one of the mounting portions being arranged on the second line, whereby the mounting portions are asymmetrically arranged, the mounting portions on the first line and the second line being passed through the mounting through holes on the first line and the second line, respectively, such that an edge of each mounting through hole is sandwiched between the corresponding mounting portion and the main body.

2. The lighting device according to claim 1, wherein:
the mounting portions include at least two first mounting portions arranged on the first line extending in the direction substantially perpendicular to the axial direction of the linear light source and at least one second mounting portion arranged on the second line extending separately from the first line in the direction substantially perpendicular to the axial direction of the linear light source; and
the mounting through holes include at least two first mounting through holes arranged on the first line extending in the direction substantially perpendicular to the axial direction of the linear light source and at least one second mounting through hole arranged on the second line extending separately from the first line in the direction substantially perpendicular to the axial direction of the linear light source.

3. The lighting device according to claim 2, wherein the first mounting portions are arranged adjacent to each other on the main body in the direction substantially perpendicular to the axial direction of the linear light source.

4. The lighting device according to claim 2, wherein the second mounting portion is arranged on an end portion of the main body in a direction substantially perpendicular to the axial direction of the linear light source.

5. The lighting device according to claim 2, wherein:
the first mounting portions are each arranged on a middle portion and one end portion of the main body in the direction substantially perpendicular to the axial direction of the linear light source; and
the second mounting portion is arranged on the other end portion of the main body in the direction substantially perpendicular to the axial direction of the linear light source.

6. The lighting device according to claim 2, wherein the first mounting portions and the second mounting portion are equally spaced apart from each other in the direction substantially perpendicular to the axial direction of the linear light source.

7. The lighting device according to claim 2, wherein:
the light source gripping portion provided on the main body comprises a plurality of light source gripping portions; and
at least one of the light source gripping portions is arranged on the first line on which the first mounting portions are arranged.

8. The lighting device according to claim 7, wherein one of the at least one of the light source gripping portions arranged on the first line on which the first mounting portions are arranged is located at a position substantially identical with a position of one of the first mounting portions on the first line.

9. The lighting device according to claim 7, wherein one of the at least one of the light source gripping portions arranged on the first line on which the first mounting portions are arranged overlaps with one of the first mounting portions in a plan view.

10. The lighting device according to claim 7, wherein one of the at least one of the light source gripping portion is arranged on the first line at a position substantially identical with a position of the second mounting portion in the direction substantially perpendicular to the axial direction of the linear light source.

11. The lighting device according to claim 1, wherein the light source holder is configured such that the edge of each of the mounting through holes is sandwiched between each of the mounting portions and the main body when the light source holder is slid in the axial direction of the linear light source with the mounting portion being passed through the mounting through hole.

12. The lighting device according to claim 11, wherein each of the mounting through holes includes a large diameter portion having a relatively large diameter, a small diameter portion having a smaller diameter than the large diameter portion, and a connecting portion that connects the large diameter portion and the small diameter portion, the small diameter portion having an edge sandwiched between the mounting portion and the main body.

13. The lighting device according to claim 10, wherein the light source holder further includes an extended portion extending from the main body in a direction opposite to a direction in which the light source holder is slid for mounting, a part of the extended portion overlapping with the large diameter portion in a plan view with the mounting portion being in the small diameter portion.

14. The lighting device according to claim 13, wherein the extended portion has a width larger than the diameter of the large diameter portion.

15. The lighting device according to claim 13, wherein:
the extended portion comprises at least three extended portions arranged corresponding to the mounting portions;
the extended portions have two different lengths measured in the axial direction of the linear light source and asymmetrically arranged.

16. The lighting device according to claim 1, wherein:
the light source gripping portion provided on the main body comprises a plurality of light source gripping portions; and
the light source gripping portions are arranged at positions substantially aligned in the direction substantially perpendicular to the axial direction of the linear light source.

17. The lighting device according to claim 1, further comprising:
an optical member arranged on a light exit side of the linear light source; and
a supporting member provided on the main body of the light source holder, the supporting member supporting the optical member.

18. The lighting device according to claim 17, wherein the supporting member and the light source gripping portions are arranged at positions substantially aligned in the direction substantially perpendicular to the axial direction of the linear light source.

19. The lighting device according to claim 18, wherein the supporting member and the light source gripping portions are equally spaced apart from each other in the direction substantially perpendicular to the axial direction of the linear light source.

20. The lighting device according to claim 17, wherein the light source gripping portions are symmetrically arranged about the supporting member.

21. The lighting device according to claim 20, wherein:
the supporting member is arranged at a middle portion of the main body; and
the light source gripping portion comprising at least two light source gripping portions, the light source gripping portions being arranged at end portions of the main body such that the supporting member is located therebetween.

22. The lighting device according to claim 21, wherein the supporting member is arranged at substantially a center of the main body.

23. The lighting device according to claim 17, wherein one of the mounting portions overlaps with the supporting member in a plan view.

24. The lighting device according to claim 17, wherein one of the mounting portions is concentrically arranged with the supporting member.

25. The lighting device according to claim 1, wherein the light source holder comprises a plurality of light source holders, the light source holders are arranged in the chassis in a zigzag pattern.

26. The lighting device according to claim 1, wherein the linear light source is a cold cathode fluorescent tube.

27. A display device comprising:
a lighting device according to any one of claims 1 to 26; and
a display panel configured to provide display using light from the lighting device.

28. The display device according to claim 27, wherein the display panel is a liquid crystal panel constructed such that a liquid crystal is sealed between a pair of glass substrates.

29. A television receiver comprising the display device according to claim 27.
